(19) United States
(12) Patent Application Publication
(10) Pub. No.: US 2017/0212607 A1
(43) Pub. Date: Jul. 27, 2017

(54) ROLLABLE MOBILE DEVICE AND METHOD FOR CONTROLLING THE SAME

(71) Applicant: LG ELECTRONICS INC., Seoul (KR)

(72) Inventor: Sunghye YOON, Seoul (KR)

(21) Appl. No.: 15/278,685

(22) Filed: Sep. 28, 2016

(30) Foreign Application Priority Data
Jan. 27, 2016 (KR) 10-2016-0010169

(51) Int. Cl. G06F 3/0346; G06T 3/60; G09G 5/00

(52) U.S. Cl. CPC G06F 3/0346; G09G 5/003; G06T 3/60; G09G 2380/02

(57) ABSTRACT

Disclosed is a rollable mobile terminal including a flexible display deformable to be rolled. The present application includes a body configured to accommodate various components, a flexible display configured to be extended from or retracted into the body, and a controller detecting a relative disposition between the display and a user based on a detected extension direction of the display, the controller controlling a content to be oriented on the display in accordance with the detected disposition.

Pursuant to 35 U.S.C. §119(a), this application claims the benefit of earlier filing date and right of priority to Korean Application No. 10-2016-0010169, filed on Jan. 27, 2016, the contents of which are hereby incorporated by reference herein in their entirety.

### BACKGROUND OF THE INVENTION

Field of the Invention

The present application relates to a mobile terminal, and more particularly, to a mobile terminal having a rollable display and method for controlling the same.

Discussion of the Related Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some terminals include additional functionality which supports electronic game playing, while other terminals are configured as multimedia players. More recently, mobile terminals have been configured to receive broadcast and multicast signals which permit viewing of contents such as videos and television programs. In order to run such functions, a mobile terminal is basically connected to other devices or network using various communication protocols and can provide a user with ubiquitous computing. In particular, a mobile terminal has been evolved into a smart device that enables the connectivity to networks and the ubiquitous computing.

Meanwhile, a flexible display capable of considerable deformation with sufficient elasticity has been developed recently. Such a flexible display can be deformed enough to be rollable. A mobile terminal accommodates a rolled-up flexible display and is able to project the display in a desired size out of its body. Hence, a mobile terminal can have a compacter structure using a flexible display. Moreover, by including such a rollable display, the mobile terminal may be called a rollable mobile terminal.

In order to use such a rollable mobile terminal, a display can be withdrawn from a body. And, the display can be extended in a size desired by a user as soon as withdrawn. Yet, the display can be extended by a user in various directions and a relative orientation or disposition of the display to the user may vary in accordance with an extended direction. Hence, in order to well show an intended content or screen to a user, a mobile terminal needs to orient a content or screen on a display in consideration of a varying display or user's relative orientation. Moreover, a mobile terminal additionally needs to adjust the oriented content in consideration of an extended direction and orientation.

### SUMMARY OF THE INVENTION

Accordingly, embodiments of the present application are directed to a mobile terminal and method for controlling the same that substantially obviate one or more problems due to limitations and disadvantages of the related art.

One object of the present application is to provide a rollable mobile terminal configured to enable a content to be oriented in consideration of extension of disposition of a display in order to provide a user with a fine view.

Another object of the present application is to provide a rollable mobile terminal, by which the oriented content can be additionally adjusted to be appropriate for user's relative orientation for a display.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a rollable mobile terminal according to one embodiment of the present application may include a body configured to accommodate various components, a flexible display configured to be extended from or retracted into the body, and a controller detecting a relative disposition between the display and a user based on a detected extension direction of the display, the controller controlling a content to be oriented on the display in accordance with the detected disposition.

Preferably, in order to determine the relative disposition between the display and the user, the controller may determine whether the user uses a prescribed hand for an extension of the display based on the detected extension direction. In order to determine the relative disposition between the display and the user, the controller may determine a manner for the user to grip the mobile terminal based on the detected extension direction. In order to determine the manner for the user to grip the mobile terminal, the controller may specify a hand for holding the display and a hand for gripping the body.

Preferably, based on the detected disposition of the user, the controller may specify portions of the display on which an upper part and/or a lower part of the content will be displayed. The controller may control the content to be oriented on the display in a manner of being vertical to the detected extension direction of the display overall. If the display is extended in a right direction, the controller may rotate the content at a prescribed angle in a counterclockwise direction from the extension direction. If the display is extended in a left direction, the controller may rotate the content at a prescribed angle in a clockwise direction from the extension direction. If the display is extended in a right direction, the controller may dispose an upper part of the content on an end portion of the display located on a left side of the extension direction, If the display is extended in a left direction, the controller may dispose the upper part of the content on an end portion of the display located on a right side of the extension direction.

Preferably, the body and the display may be oriented to be substantially horizontal to a gravity direction. And, only the display may be moved by the user for an extension of the display.

Preferably, if both of the body and the display are moved by the user for a display extension, the controller may detect moving directions and accelerations of the display and the body and may determine the moving direction of either the display or the body, which has a greater acceleration, as the extension direction of the display. And, each of the body and the display may include an acceleration sensor configured to measure a size and direction of the acceleration.

Preferably, the controller may be configured to provide a different user interface according to the extension direction of the display. The controller may be configured to dispose a virtual interface at a different position according to the extension direction of the display. In particular, the controller may control a virtual input unit to be disposed on the display in a manner of being adjacent to the extension direction of the display. And, the controller may control a virtual input unit to be disposed adjacent to a hand for moving the display. Moreover, if the display is extended in a right direction, the controller may dispose a virtual input unit on a right end portion of the display. If the display is extended in a left direction, the controller may dispose the virtual input unit on a left end portion of the display.

Preferably, the controller may set a physical interface to perform a different function according to a moving direction of the display. In particular, the controller may be configured to assign a same function to user's same manipulation on a prescribed physical input device. And, the controller may be configured to assign a same function to a physical input device located at a same relative position to the user.

Effects obtainable from the present invention may be non-limited by the above mentioned effect. And, other unmentioned effects can be clearly understood from the following description by those having ordinary skill in the technical field to which the present invention pertains. Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present application will become more fully understood from the detailed description given herein below and the accompanying drawings, which are given by illustration only, and thus are not limitative of the present application, and wherein:

FIG. 1A is a block diagram to describe a mobile terminal related to the present application;

FIG. 1B and FIG. 1C are perspective diagrams of one example of a mobile terminal related to the present application, viewed in different directions;

FIG. 1D is a perspective diagram of a mobile terminal including a flexible display;

FIG. 2 is a perspective diagram of a mobile terminal according to one embodiment of the present application;

FIG. 3A is a diagram to describe a first state of a mobile terminal according to one embodiment of the present application;

FIG. 3B is a diagram to describe a second state of a mobile terminal according to one embodiment of the present application;

FIG. 4 is an exploded perspective diagram of a mobile terminal according to one embodiment of the present application;

FIG. 5A is a rear diagram of a mobile terminal according to a first embodiment of the present application;

FIG. 5B is a cross-sectional diagram of a mobile terminal according to a second embodiment of the present application;

FIG. 5C is a rear diagram of a portion of a mobile terminal according to a third embodiment of the present application;

FIG. 6 is a partial cross-sectional diagram of a mobile terminal according to one embodiment of the present application;

FIG. 7 is a cross-sectional diagram of a display unit according to one embodiment of the present application;

FIG. 8 is a cross-sectional diagram of a mobile terminal according to one embodiment of the present application;

FIG. 9 is a diagram to describe disposition of a first magnetic member and a second magnetic member according to one embodiment of the present application;

FIG. 10 is a cross-sectional diagram along a cutting line A-A shown in FIG. 9;

FIG. 11 is a diagram to describe of a joint relation between an inner case and a middle case according to one embodiment of the present application;

FIG. 12A is a partial layout of a mobile terminal in a second state according to one embodiment of the present application;

FIG. 12B is a cross-sectional diagram along a cutting line B-B shown in FIG. 12A;

FIG. 12C is a cross-sectional diagram along a cutting line C-C shown in FIG. 12A;

FIG. 13A is a diagram to describe an unfolded state of a circuit board according to one embodiment of the present application;

FIG. 13B and FIG. 13C are diagrams to describe a connected state in case of stacking the circuit boards shown in FIG. 13A;

FIG. 14A and FIG. 14B are separate diagrams of a Hall sensor shown in FIG. 12C;

FIG. 15 is a flowchart for one example of a method of controlling a mobile terminal described in the present application;

FIG. 16 is a detailed flowchart of a detecting step of relative disposition shown in FIG. 15;

FIG. 17 is a detailed flowchart of an orientation step of a content shown in FIG. 15;

FIG. 18 is a detailed flowchart of an extended direction detecting step shown in FIG. 11;

FIG. 19 is a layout to describe user's tendency for a display extension;

FIG. 20 is a front diagram of a mobile terminal oriented overall in a direction horizontal to a gravity direction;

FIG. 21 is a front diagram of a mobile terminal oriented overall in a direction vertical to a gravity direction;

FIG. 22 is a layout of a body and display moving together for extension of the display;

FIG. 23 is a flowchart for another example of a method of controlling a mobile terminal described in the present application;

FIG. 24 is a layout for one example of a user interface provided by the controlling method shown in FIG. 23;

FIG. 25 is a layout for another example of a user interface provided by the controlling method shown in FIG. 23;

FIG. 26 is a layout for further example of a user interface provided by the controlling method shown in FIG. 23;

FIG. 27 and FIG. 28 are layouts for examples of a user interface provided by the controlling method shown in FIG. 23 when sizes of a display and screen are changed;

FIG. 29 is a flowchart for further example of a method of controlling a mobile terminal described in the present application; and

FIG. 30 is a layout for one example of a user interface provided by the controlling method shown in FIG. 29.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

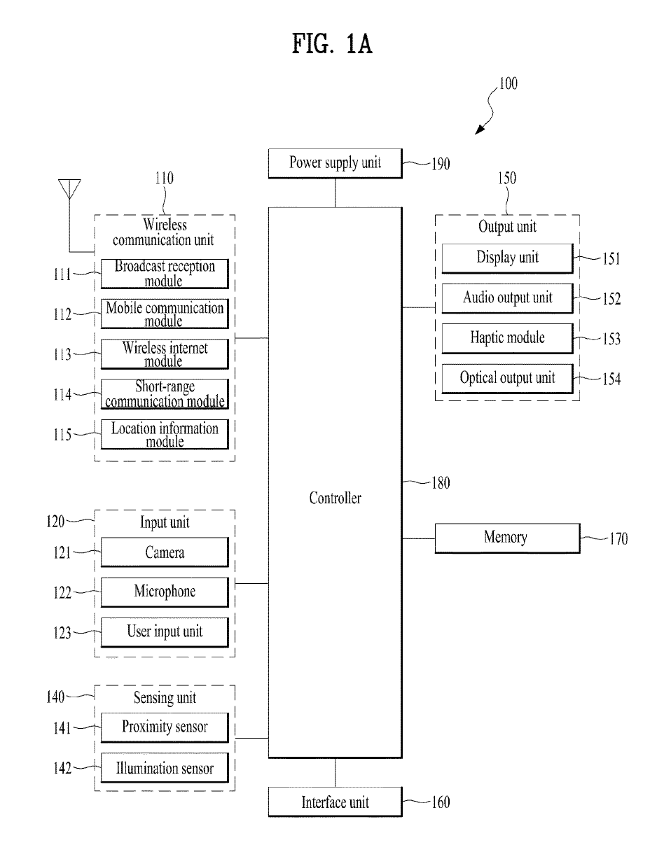

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102.

Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Meanwhile, the mobile terminal according to the present application can displays the information using a flexible display. FIG. 1d is a conceptual view of the mobile terminal having the flexible display. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251.

Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

As mentioned in the foregoing description, the flexible display unit 251 can be deformed enough to be rollable. Hence, the mobile terminal 200 can have a body configured to accommodate the rolled-up flexible display unit 251 instead of the case 201. And, the accommodated display unit 251 can be withdrawn from the body in a desired size. Using a rollable display, the mobile terminal 200 can have a compacter structure and may be called a rollable mobile terminal. In the following description, embodiments related to the above-configured rollable mobile terminal 200 shall be described with reference to the accompanying drawings. It will be appreciated by those skilled in the art that various modifications and variations can be made in the present application without departing from the spirit or scope of the inventions.

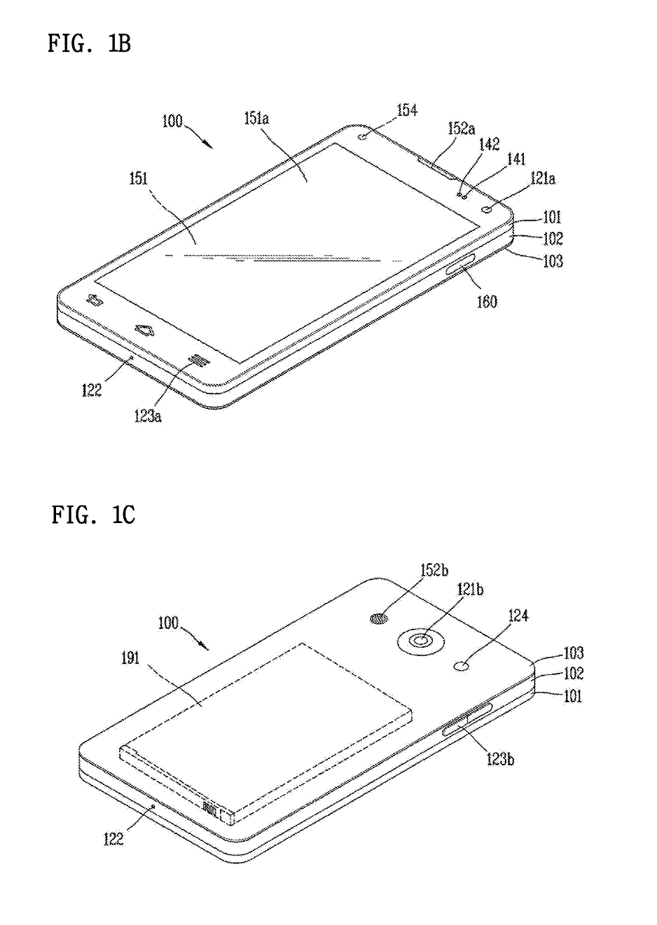

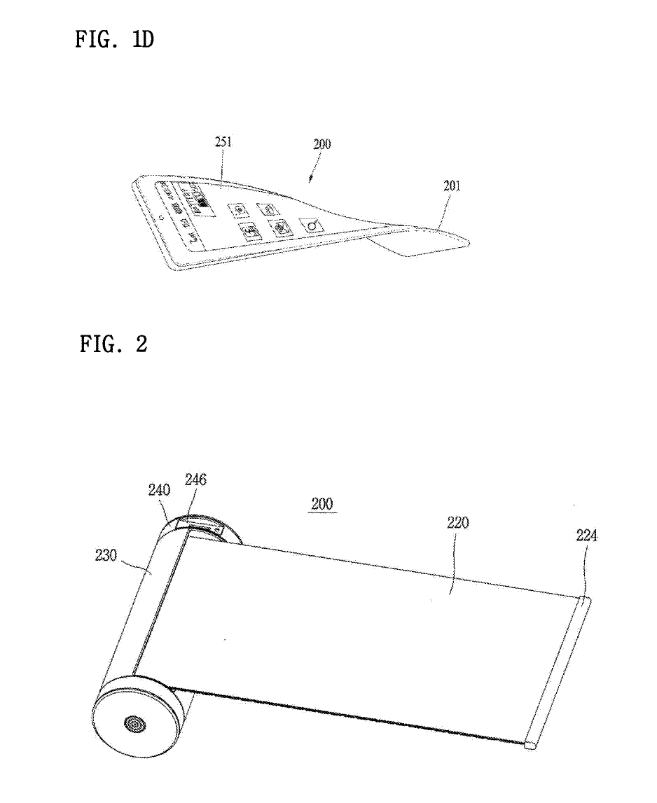

FIG. 2 is a perspective diagram of a mobile terminal 200 according to one embodiment of the present application, FIG. 3A is a diagram to describe a first state of a mobile terminal 200 according to one embodiment of the present application, and FIG. 3B is a diagram to describe a second state of a mobile terminal 200 according to one embodiment of the present application.

According to one embodiment of the present application, a mobile terminal 200, of which display region for displaying a screen can be adjusted by a user easily and conveniently, is provided. In this case, the display region can extend or reduce an externally exposed region by a rolling. In particular, the mobile terminal 200 according to one embodiment of the present application may include a body part 210 configured to have various electronic parts or components embedded therein and a display unit 220 configured to be accommodated in the body part 210 in a first state or to be externally exposed from the body part 210 in a second state.

According to one embodiment of the present application, the first state of the mobile terminal 200 corresponds to a deactivated state of the mobile terminal 200 and means a state that a minimum display region is externally exposed to display a basic part only. Moreover, in the first state, the display unit 220 may be fully accommodated in the body part 210 to avoid being exposed from the body part 210. On the other hand, the second state of the mobile terminal 200 means a state that the display region is extended from the first state. In doing so, the extension includes a stepwise extension. The display region of the mobile terminal 200 may be extended or reduced by rolling the display unit 220. Although the display region of the mobile terminal 200 may be embodied in a manner of being extended or reduced once, the display region can be changed in a manner of being gradually extended or reduced step by step. Hence, in the following description, every state except the first state may be the second state. And, the second state can be divided into multiple steps.

The body part 210 may include a hollow type middle case 230 having a first magnetic member 233 provided therein, a first case 240, a first case 240 provided to a top portion of the body part 210 by being separable from the middle case 230, and a second case 250 provided to a bottom of the body part 210 by being separable from the middle case 230. Thus, the body part 210. Thus, the body part 210 can be divided into three elements. And, the first case 240, the middle case 230 and the second case 250 form an exterior of the mobile terminal 200. The middle case 230 may have a roughly cylindrical shape, and the first case 240 and the second case 250 are configured to cover a top and bottom of the middle case 230, respectively. Owing to the first case 240 and the second case 250, various parts or components provided within the middle case 230 can be hidden without being externally exposed. According to one embodiment of the present application, a magnetic member may include a magnet.

A first speaker 251 and a second speaker 252 may be provided to the first case 240 and the second case 250, respectively. And, speaker holes 251a and 252a may be formed in the first and second speakers 251 and 251, respectively. Thus, according to one embodiment of the present application, the speakers are provided to both sides of the middle case 230, thereby configuring dual speakers. And, an antenna 245 may be provided to at least one of the first case 240 and the second case 250.

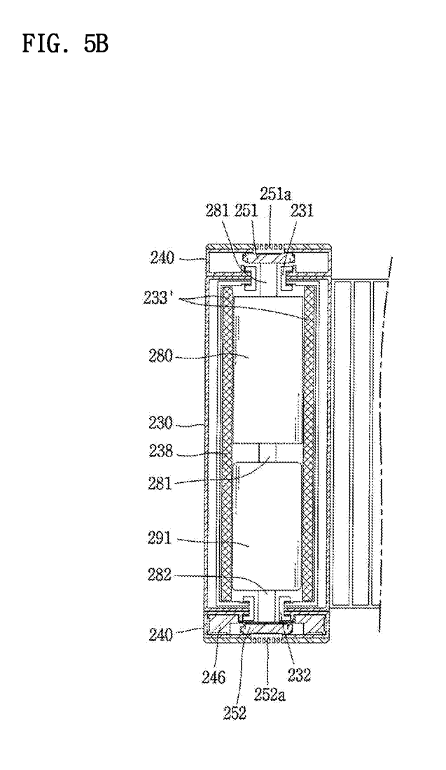

According to one embodiment of the present application, a camera 241 and an audio output unit 242 may be installed in a portion of the first case 240 or the second case 250. In particular, referring to FIG. 3A and FIG. 3B, the camera 241 and the audio output unit 242 are configured to face the same direction all the time in each of the first state and the second state by being provided to a portion of an outer surface of the first case 240. Referring to FIG. 3A and FIG. 8, a recess portion 246 configured to be recessed toward an inside of the first case 240 is formed in the first case 240 not to form a curved surface but to form a flat surface. And, the camera 241 and the audio output unit 242 are provided to the recess portion 246.

Moreover, in the first state, as shown in FIG. 3A, by displaying such regions as a message window 225, icons 26, a time display unit 227 and the like, it is able to minimize an exposed region of the display unit 220. Yet, in the second state, as shown in FIG. 3B, by maximizing an exposed region of the display unit 220, it is able to display a screen on a bigger screen. The message window 225, the icon 226 and the time display unit 227 are displayed in a basic state of the display unit 220.

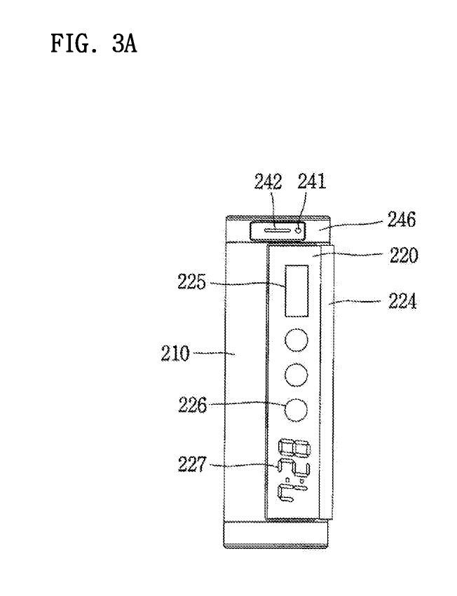

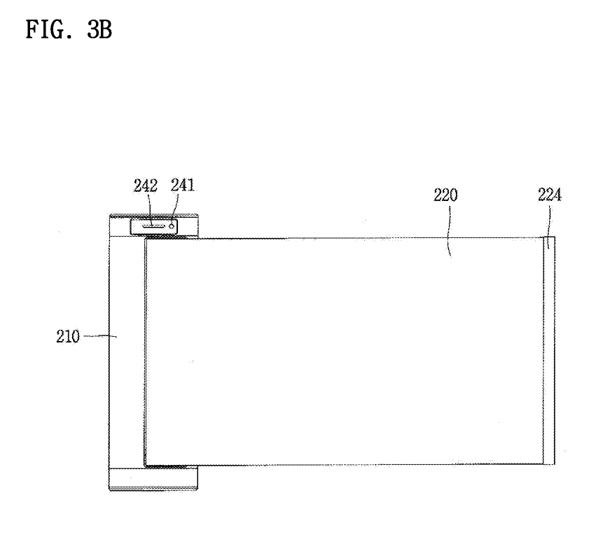

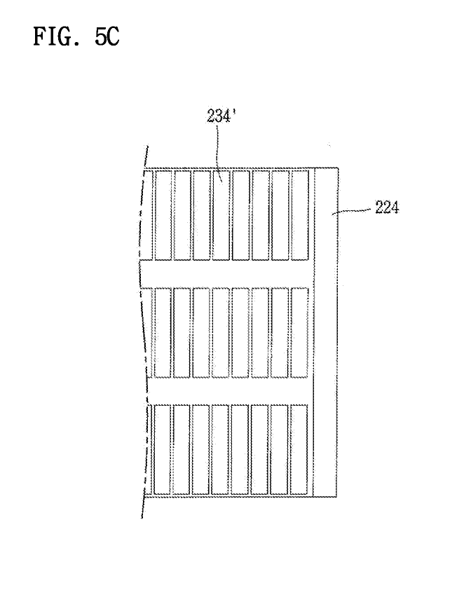

FIG. 4 is an exploded perspective diagram of a mobile terminal 200 according to one embodiment of the present application, FIG. 5A is a rear diagram of a mobile terminal 200 according to a first embodiment of the present application, FIG. 5B is a cross-sectional diagram of a mobile terminal 200 according to a second embodiment of the present application, and FIG. 5C is a rear diagram of a portion of a mobile terminal 200 according to a third embodiment of the present application. Moreover, FIG. 9 is a diagram to describe disposition of a first magnetic member 233a/333b and a second magnetic member 234 according to one embodiment of the present application.

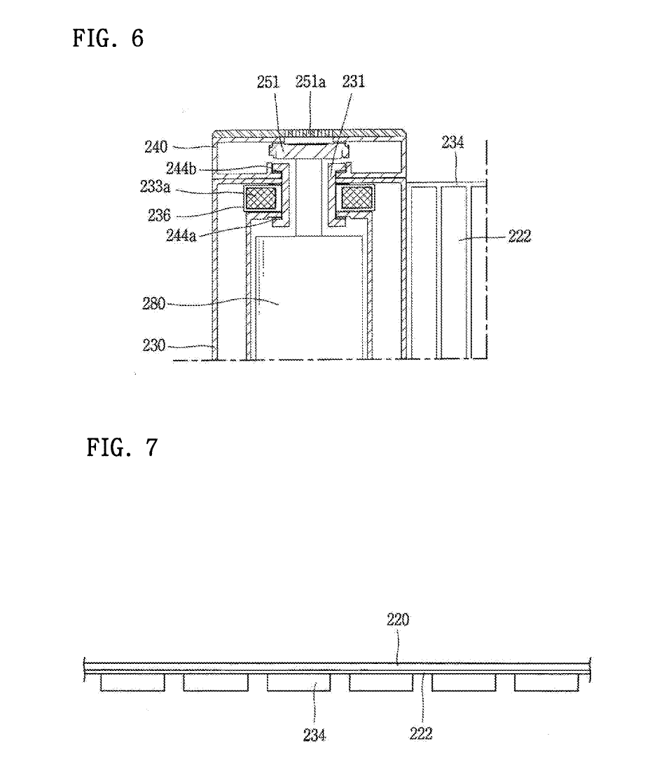

In the following description, one embodiment of the present application shall be described with reference to FIGS. 4 to 5C, FIG. 9 and FIG. 10.

First of all, according to one embodiment of the present application, in order to adjust an externally exposed region of the display unit 220, the display unit 220 is rolled to be wound/rolled/coiled or unwound/unrolled/uncoiled on the middle case 230. In particular, the middle case 230 plays a role as a bobbin. To this end, according to one embodiment of the present application, magnet (or magnetism) is used. In particular, the inner case 238 in a cylindrical shape is provided within the middle case 230 and the display unit 220 is rolled up on the inner case 238 by being rotated together with the inner case 238.

As a multitude of second magnetic members 234 are provided to a bottom of the display unit 220 in a manner of being spaced apart from each other along a first direction, the second magnet members 234 are sequentially moved by the attraction with the first magnetic member 233, whereby the display unit 220 is rolled. For instance, if the first magnetic member 233a/233b and the second magnet member 234 have N pole and S pole, respectively, they are attracted to each other by magnetism. In particular, since the first magnetic member 233a/233b is fixed or stationary, the second magnetic member 234 is pulled toward the first magnetic member 233a/233b by performing a rectilinear motion. In doing so, the second magnetic members 234 contiguously spaced apart from each other keep entering the middle case 230. Since the attraction between the first magnetic member 233 and the second magnetic members 234 having entered the middle case 230 already keeps working, it is able to keep a balance with an attraction between the first magnetic member 233 and a newly entering second magnetic member 234, whereby the second magnetic members 234 are rotated centering on the first magnetic member 233. By such mechanism, the display unit 220 is wound by being rolled up in the middle frame.

Thus, according to a first embodiment of the present application, the first and second magnetic members 233a and 233b performing rotational motions by being respectively connected to the first and second shafts 231 and 232 are disposed to have the same polarity different from that of the second magnetic member 234. In doing so, an attractive force between the first and second members 233a/233b and 234 by the attraction is converted into a rotational motion. In particular, since the second magnetic member 234 having entered the middle case 230 is formed on an outer circumference of the inner case 238, as the second magnetic member 234 intending to newly enter the middle case 230 is attracted to the inner case 238 by the attraction with the first magnetic member 233a/233b, the second magnetic member 234 having entered earlier starts to rotate. Subsequently, as the inner case 238 rotates by itself, the second magnetic member 234 enters the middle case 230.

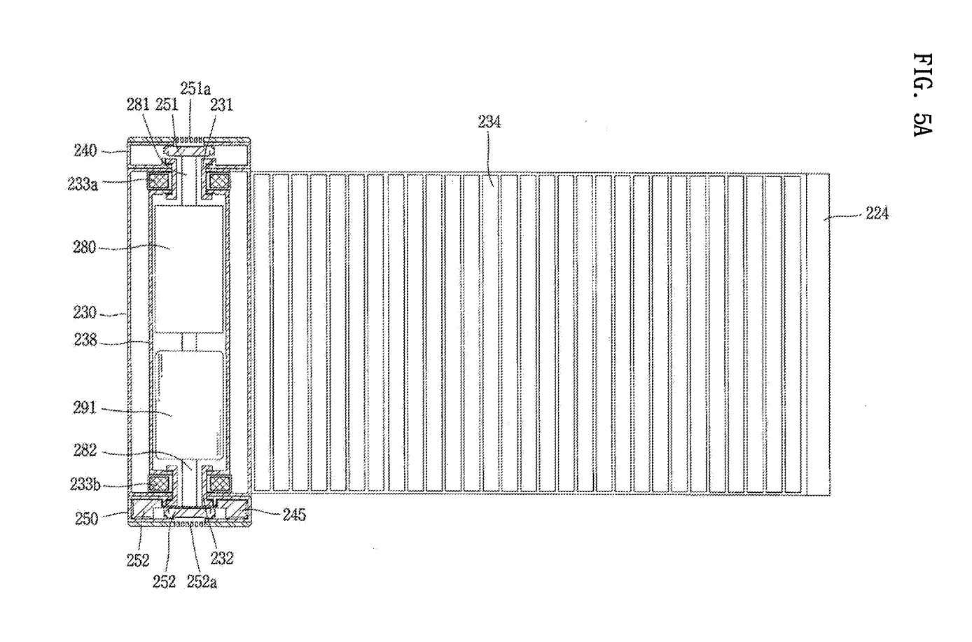

FIG. 7 is a cross-sectional diagram of the display unit 220 according to one embodiment of the present application. Referring to FIG. 7, a sheet 222 having a multitude of the magnetic members 234 provided thereto is provided to a bottom surface of the display unit 220. In this case, the sheet 222 needs to be formed of a flexible material. For instance, the sheet 222 may be formed of silicon or TPU (thermoplastic polyurethane). The sheet 222 is attached to a backside surface of the display unit 220 in form of a sheet frame. The sheet 222 sequentially fixes the second magnetic members 234 and may be formed by boding, tape or insert molding. Moreover, the sheet 222 should have a flexible property with small thickness and use a material having excellent elasticity and elongation. The reason for this is described as follows. First of all, since a multitude of the second members 234 have the same magnetic pole, the display unit 200 can be unfolded flat by the repulsive force thereof. In particular, the second magnetic members 234 having the same magnetic pole generate the repulsive force to push the another magnetic member 234 formed adjacent, whereby the display unit 220 can be unfolded flat in the second state.

Referring to FIG. 5A, the mobile terminal 200 further includes a first shaft 231 provided between the first case 240 and the middle case 230 and a second shaft 232 provided between the second case 250 and the middle case 230. Each of the first shaft 231 and the second shaft 232 has a cylindrical shape of which both ends are open. The first shaft 231 may be fixed to the first case 240 or the inner case 238. And, the second shaft 232 may be fixed to the second case 250 or the inner case 238. If the first shaft 231 and the second shaft 232 are fixed to the first case 240 and the second case 250, respectively, the inner case 238 is rotated independently from each of the first case 240 and the second case 250. Thus, the inner case 238 plays a role as a mandrel to enable to display unit 220 to be wound, rolled, or coiled.

To this end, each of the first shaft 231 and the second shaft 232 should have one end portion of its own fixed only or should have both end portions of its won not fixed. If the first shaft 231 is fixed to the first case 240 and the inner case 238, as a rotational force of the inner case 238 is transferred to the first case 240 as well, the first case 240 is rotated together. Likewise, if the second shaft 232 is fixed to the second case 250 and the inner case 238, a rotational force of the inner case 238 is transferred to the second case 250, both of the inner case 238 and the second case 250 are rotated together. To prevent this, one end portion of each of the first shaft 231 and the second shaft 232 is fixed, while the other becomes a free end. Moreover, if both end portions of each of the first shaft 231 and the second shaft 232 is fixed to none of the first case 240, the second case 250 and the inner case 238, the inner case 238 is rotated independently from each of the first case 240 and the second case 250.

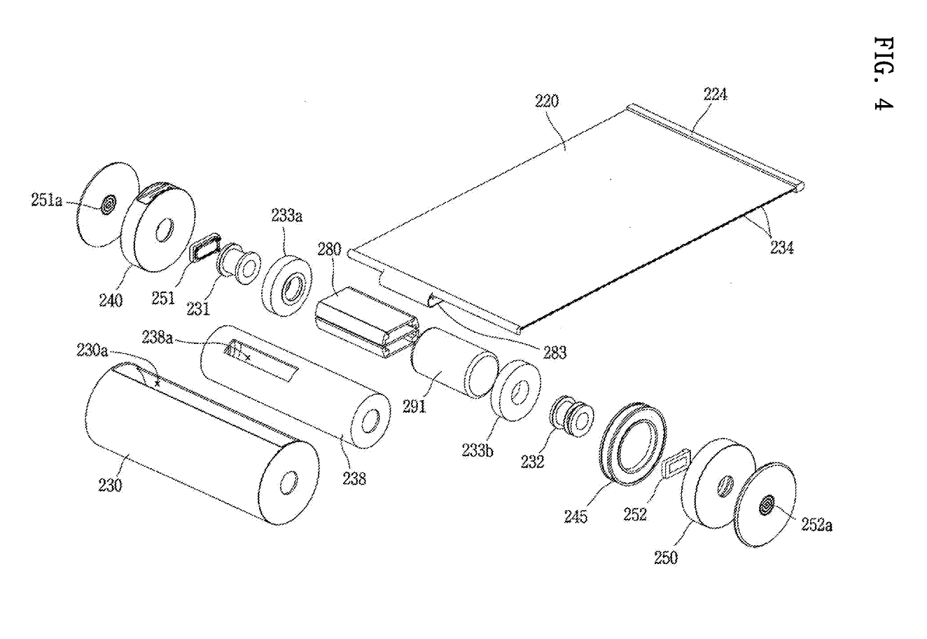

Enabling each of the first shaft 231 and the second shaft 232 to work as a free end or a stationary end is performed by washers 244a and 244b provided to one or both sides of each of the first shaft 231 and the second shaft 232. Each of the washers 244a and 244b has a donut shape and is able to adjust an extent in transferring a frictional force between two parts coming into contact with each other. According to one embodiment of the present application, as shown in FIG. 6, the washers 244a and 244b are provided to both end portions of the second shaft 252 configured to connect the second case 250 and the middle case 230 to each other. In particular, the first washer 244a is provided between the inner case 238 and the second shaft 232, while the second washer 244b is provided between the second case 250 and the second shaft 232. By lowering the frictional force of one of the first washer 244a and the second washer 244b, the second shaft 232 can be prevented from transferring the rotational force of the inner case 238 to the second case 250.

For instance, if the frictional force of the first washer 244a is raised but the frictional force of the second washer 244b is lowered, the rotational force of the inner case 238 is transferred to the second shaft 232 so that the second shaft 232 is rotated together with the inner case 238. In doing so, since the rotational force of the second shaft 232 is not transferred to the second case 250, the inner case 238 can be rotated independently from the second case 250. Since such mechanism is identically applicable to the relation between the first shaft 231 and the first case 240, its details shall be omitted from the following description.

According to a first embodiment of the present application, as shown in FIG. 5A, the first magnetic member 233 is provided to an outer circumference of each of the first shaft 231 and the second shaft 232. In particular, each of the first shaft 231 and the second shaft 232 has ‘H’ shape roughly and the first magnetic members 233a and 233b are configured to enclose middle portions of the first shaft 231 and the second shaft 232, respectively. In particular, the first magnetic members 233a and 233b are disposed on outer circumferences of the first shaft 231 and the second shaft 232 along a second direction vertical to the first direction, respectively.

The first magnetic members 233a and 233b are formed as a pair and provided to both ends of the inner case 238, respectively. FIG. 5A shows one example that the first magnetic members 233a and 233b are disposed at both ends of the inner case 238, by which the present embodiment is non-limited. If necessary, the first magnetic member 233 may be further provided to a middle portion of the inner case 238. In this case, a pair of the first magnetic members 233a and 233b have donut shapes. Magnetic poles of the portions of the first magnetic members 233a and 233b getting away from center axes of the first shaft 231 and the second shaft 232 are equal to each other and are opposite to the magnetic pole of an exposed portion of the second magnetic member 234. So to speak, the first magnetic member 233 and the second magnetic member 234 are disposed in a manner of attraction can work between the first magnetic member 233 and the second magnetic member 234.

Furthermore, according to a second embodiment of the present application, as shown in FIG. 5B, the first magnetic member 233′ are formed in a cylindrical shape. And, the first magnetic member 233′ can be formed long along the second direction. In this case, according to one embodiment of the present application, the first direction is a direction of inserting the display unit 220 into the middle case 230 or a direction of withdrawing the display unit 220 from the middle case 230 and may mean a moving direction of the display unit 220. And, the second direction means a direction of connecting the first case 240 and the second case 250 to each other by being vertical to the first direction. In this case, a line of connecting the first shaft 231 and the second shaft 232 to each other may correspond to a center axis of the body part 210 or a rotational axis of the inner case 230.

Since the second embodiment of the present application is almost identical to the first embodiment except the shape of the first magnetic member 233, the second embodiment has the same structure of the first embodiment unless contravened specially. Hence, the description of the mobile terminal 200 according to the second embodiment shall be omitted. The first magnetic member 233′ may be provided to an inner or outer circumferential surface of the inner case 238. FIG. 5B shows one example that the first magnetic member 233′ is provided to the inner circumferential surface of the inner case 238. According to the second embodiment, if the display unit 220 is unwound, unrolled or uncoiled, the first magnetic member 233′ is rotated together with the inner case 238.

Moreover, a third embodiment of the present application relates to a case that a second magnetic member 234′ is formed in a manner of being divided into a multitude of second magnetic members along the first direction with the same polarity. According to the first or second embodiment, the second magnetic member 234 attached to the display unit 220 is formed long in a length corresponding to the inner case 238 along the second direction. Yet, according to the third embodiment, the second magnetic member is formed into at least two second magnetic members 234′. Thus, if the second magnetic member 234 is divided into a number of second magnetic members 234′, it is able to reduce the required quantity of the magnetic member. Since the rest of the third embodiment is identical to the aforementioned first embodiment, its details shall be omitted from the following description.

According to one embodiment of the present application, a circuit board 280 and a battery 291 are provided to the middle case 230, and a multitude of parts or components are built in the first case 240 and the second case 250. A multitude of the parts or components are connected to the circuit board 280 and are electrically connected to a first flexible circuit board 281 and a second flexible circuit board 282 formed along insides of the first shaft 231 and the second shaft 232. This, in order to dispose the first flexible circuit board 281 and the second flexible circuit board 282, the first shaft 231 and the second shaft 232 are hollowed. And, the first flexible circuit board 281 and the second flexible circuit board 282 are disposed through inner spaces of the first shaft 231 and the second shaft 232.

The middle case 230 has a cylindrical shape. And, both end portions (bottom surfaces) of the middle case 230 are circular. Moreover, a hole is formed at the center of each of the end portions of the middle case 230 to prevent the parts provided within the middle case 230 from leaving the middle case 230. Such configuration is also applied to the inner case 238. A first cut slot 230a is formed in the middle case 230 in a manner of cutting a portion of the middle case 230 along the second direction to enable to display unit 220 to be wound and unwound. Similarly, a second cut slot 238a is formed in the inner case 238 along the second direction to enable a third flexible circuit board 283, which is configured to electrically connect the display unit 220 to the circuit board 280, to be inserted. And, the inner case 238 is disposed to have concentric circles with the middle case 230. In doing so, the first cut slot 230a is formed through a whole section of the middle case 230 along the second direction, while the second cut slot 238a is formed through a partial section of the inner case 238 along the second direction. Since the display unit 220 is inserted or withdrawn through the first cut slot 230a, a length of the first cut slot 230a along the second direction should be equal to or greater than a width of the display unit 220. Yet, since the third flexible circuit board 283 having a width smaller than that of the display unit 220 is inserted in the second cut slot 238a, the second cut slot 238a may have a length equal to or greater than the width of the third flexible circuit board 283.

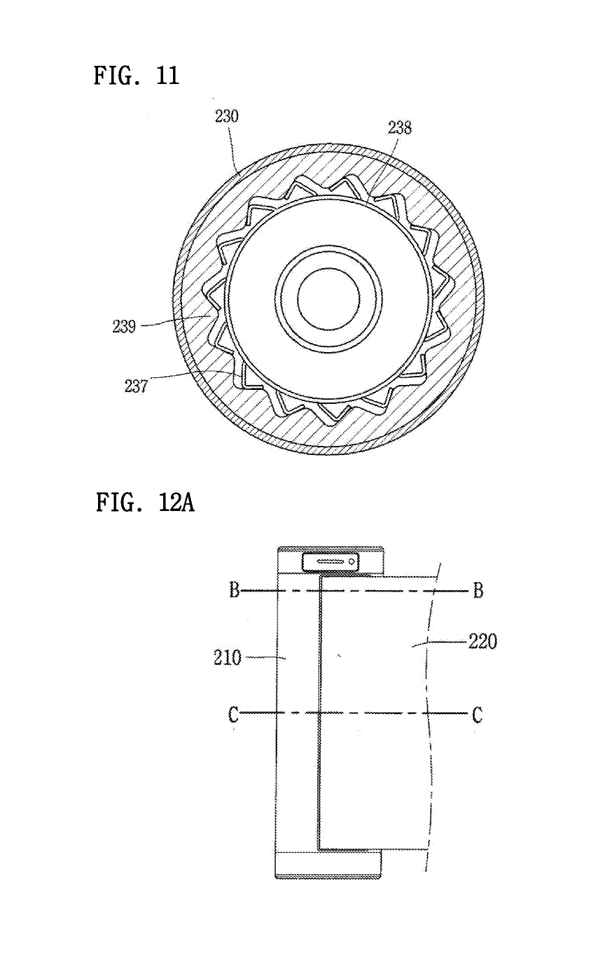

FIG. 8 is a cross-sectional diagram of a mobile terminal 200 according to one embodiment of the present application, and shows that the circuit board 280 provided within the inner case 238 is configured with three stories. Regarding this, FIG. 13A is a diagram to describe an unfolded state of the circuit board 280 according to one embodiment of the present application. FIG. 13B and FIG. 13C are diagrams to describe a connected state in case of stacking the circuit board 280 shown in FIG. 13A. Referring to FIG. 13A and FIG. 13B, first to third circuit boards 280a, 280b and 280c in rigid plate shapes are provided. And, the first to third circuit boards 280a, 280b and 280c are electrically connected to each other by a flexible connecting part 285. In this case, the connecting part 285 may include a cable or a flexible circuit board. The first to third circuit boards 280a, 280b and 280c are general circuit boards and correspond to rigid parts. In order to be disposed in a narrow space, the first to third circuit boards 280a, 280b and 280c are divided into a multitude of regions that are electrically connected to each other.

Thus, according to one embodiment of the present application, at least two circuit boards are provided in a manner of being electrically connected to each other by the flexible connecting part, whereby the circuit board 280 can be disposed in the narrow inner space of the inner case 238. In this case, as the first to third circuit boards 280a, 280b and 280c are stacked in a manner that the connecting parts 285/287 configured to connect the first to third circuit boards 280a, 280b and 280c to each other are disposed on positions opposite to each other, it is able to prevent the connecting parts 285/287 from intertwining or interfering with each other.

Moreover, referring to FIG. 13C, a connector 286 is provided to one surface of each of the first to third circuit boards 280a, 280b and 280c and is then connected to the connecting part 287, whereby the first to third circuit boards 280a, 280b and 280c can be electrically connected to each other. In this case, the connecting part 287 may be identical to the former connecting part 285. Yet, the connecting part 287 may include a simple cable connected to the connector 286. And, the connecting part 287 may include one of all electric devices capable of connecting two points to each other unless special restrictions are put thereon.

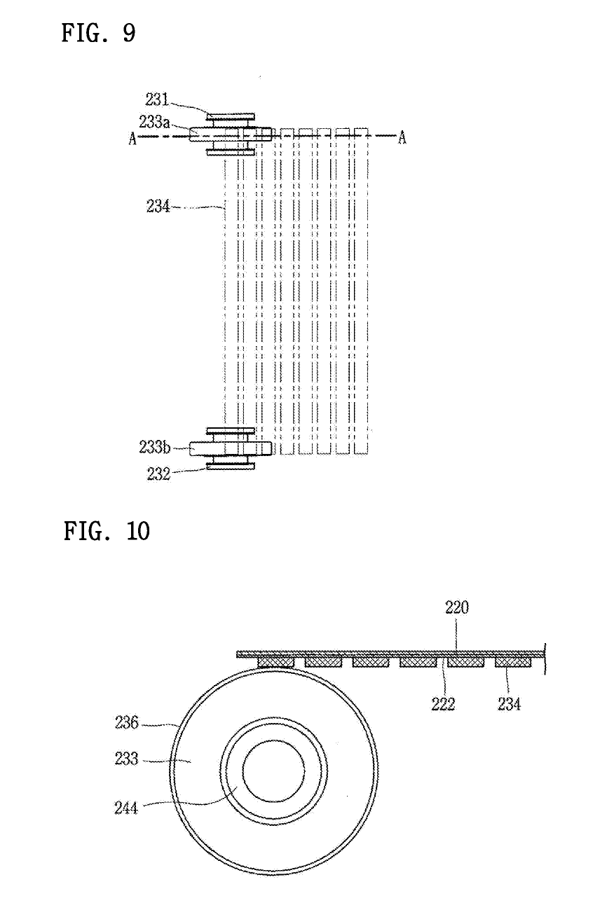

The above-configured circuit board 280 may be provided within the inner case 238 by being supported by a support frame 262, as shown in FIG. 12C. In particular, as the support frame 262 having a space for enabling the first to third circuit boards 280a, 280b and 280c to be seated therein is fixed to an inside of the inner case 238, the circuit board 280 is disposed.

Moreover, referring to FIG. 6, a hold case 236 is provided to an outer circumference of the first magnetic member 233a. In this case, the hold case 236 is a member for accommodating the first magnetic member 233 therein and plays a role in fixing the first magnetic member 233a in the donut shape to prevent the first magnetic member 233a from moving as well as a role in fixing the first shaft 231. In particular, the hold case 236 is provided between the middle case 230 and the inner case 238 and plays a role in preventing the first shaft 231 from moving up and down. This mechanism is applied to the second shaft 232 in the same manner

In this case, the hold case 236 may use such a material having small friction as POM (polyoxymethylene) to reduce rolling friction.

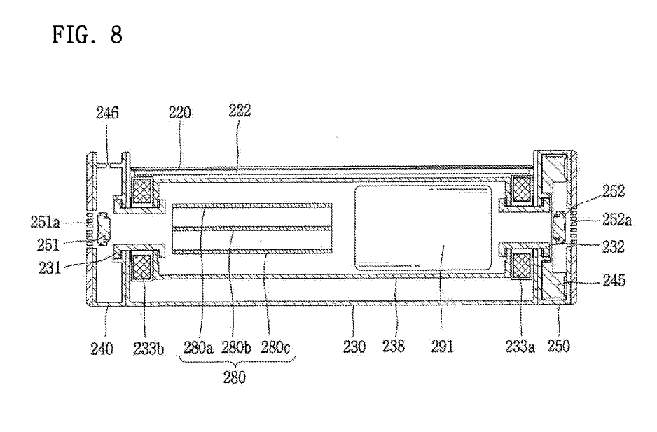

Meanwhile, in the mobile terminal 200 according to one embodiment of the present application, the display unit 220 is pulled to be externally exposed. After the display unit 220 has been externally exposed, it should maintain the second state while the external force applied by the user is removed. In order for the user to maintain the second state by pulling the display unit 220, if it is necessary for an end portion of the display unit 220 to be fixed, it may cause inconvenience to the user. To solve the problem of inconvenience, according to one embodiment of the present application, a structure shown in FIG. 11 is proposed.

FIG. 11 is a diagram to describe of a joint relation between an inner case 238 and a middle case 230 according to one embodiment of the present application. Referring to FIG. 11, a multitude of first projections 237 are formed in a circumferential direction on an outer circumference surface of the inner case 238. And, a multitude of second projections 239 are formed to correspond to the first projections 237 on an inner circumference surface of the middle case 230 in a manner that corresponding positions of the second projections 239 are changed sequentially in response to a rotation of the inner case 238. The first projection 237 is formed by being projected from the outer circumference surface of the inner case 238. An end portion of the first projection 237 is not fixed to the inner case 238 and has a bent shape. This is to provide elasticity because the first projection 237 should move by coming in contact with the second projection 239. In particular, if the first projection 237 stops while contacting with the second projection 239, the end portion of the first projection 237 is spaced apart from the outer circumference surface of the inner case 238. Yet, while positions of contacts between the first projections 237 and the second projections 239 are changed, as the second projections 239 press the first projections 237, the end portions of the first projections 237 should contact with the outer circumference surface of the inner case 238 or should be spaced apart from the outer circumference surface of the inner case 238 until barely contacting with outer circumference surface of the inner case 238. To this end, according to one embodiment of the present application, the first projections 237 are formed in hook shape to have elasticity. It is unnecessary for the first and second projections 237 and 239 to be formed on the whole portions of the inner case 238 and the middle case 230. And, the first and second projections 237 and 239 may be formed on the inner case 238 and the middle case 230 in part only. Yet, to this end, a length of each of the inner case 238 and the middle case 230 should be formed longer than a width of the display unit 220. The reason for this is described as follows. First of all, since the display unit 220 is wound, rolled or coiled on the outer circumference surface of the inner case 238, a space for not winding the display unit 220 is required.

In doing so, while the inner case 238 stops instead of rotating, the first projection 237 and the second projection 239 configure a concavo-convex (ma) or gear engaging. Yet, the concavo-convex (ma) or gear engaging is not a strong coupling that is not released despite applying an external force. If a force over a predetermined level is externally applied, the concavo-convex (ma) or gear engaging occurs at a new position owing to a rotation of the inner case 238.

If a user intends to switch the display unit 220 to the second state by pulling the display unit 220 in the first state, the user can just pull the display unit 220 as long as a desired moving distance. In doing so, since the second projection 239 of the middle case 230 is fixed or stationary, once the first and second projections 237 and 239 engage with each other, although an external force is removed, the unwound, unrolled or uncoiled display unit 220 maintains the second state by maintaining the external force removed state. In particular, in case that the user pulls the display unit 220 at high speed, the first and second projections 237 and 239 move without being almost caught on each other. On the other hand, in case that the user pulls the display unit 220 at low speed, the first and second projections 237 and 239 move stepwise. Thus, if the display unit 220 is puled slowly, the first and second projections 237 and 239 maintain the engaging state in the first place, move by being released from the engaging, and then maintain the engaging state again. Thus, the first and second projections 237 and 239 repeat such motions. Once the engaging state is entered, it is maintained without being released unless applying an external force externally thereto.

Therefore, according to one embodiment of the present application, it is able to adjust a size of the region of the display unit 220 step by step.

FIG. 12A is a partial layout of a mobile terminal 200 in a second state according to one embodiment of the present application, FIG. 12B is a cross-sectional diagram along a cutting line B-B shown in FIG. 12A, and FIG. 12C is a cross-sectional diagram along a cutting line C-C shown in FIG. 12A.

Referring to FIG. 12B, as a first holder 223 is provided to an inner end portion of the display unit 220 along the second direction, it can be observed that the first holder 223 is caught at a groove 236a formed in an outer circumference surface of the inner case 238 in the second state. Thus, as the end portion of the display unit 220 is fixed to the inner case 238, even if a user forces the display unit 220 to be pulled, the display unit 220 is not separated from the inner case 238.

Similarly, as a second holder 224 is formed long on an outer end portion of the display unit 220 along the second direction, the second holder 224 can prevent the display unit 230 from rolled up into the middle case 230. In particular, as shown in FIG. 3A and FIG. 4, the second holder 224 is caught at the cut slot 230a of the middle case 230, it is prevented from entering the middle case 230a.

FIG. 12B is a diagram to describe that the display unit 220 is wound, rolled or coiled by the attraction between the second magnetic members 234 provided to the bottom of the display unit 220 and the first magnetic member 233 provided within the middle case 230. In doing so, a magnetic pole of an exposed portion of the second magnetic member 234 has polarity different from that of an outer surface portion of the first magnetic member 233. This can be understood through the former description of the winding/rolling process of the display unit 220 and its details shall be omitted from the following description.

FIG. 12C shows that the display unit 220 is connected to the inner case 238 by the third flexible circuit board 283 so as to be connected to the circuit board 280 provided within the inner case 238. In this case, as mentioned in the foregoing description, the circuit board 280 can be configured with 3 stories. And, the circuit board 262 is provided to the support frame 262. To this end, as shown in FIG. 4, the second cut slot 238 is formed in the inner case 238 so that the third flexible circuit board 283 can be inserted into the second cut slot 238.

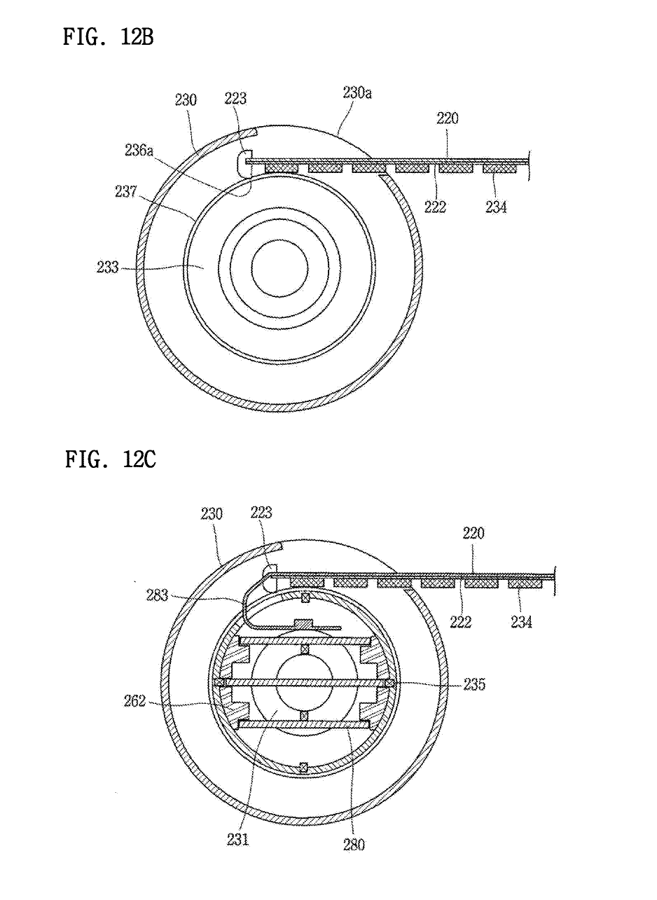

Referring to FIG. 12C, a multitude of Hall sensors (Hall ICs) are provided to an inner circumference surface of the inner case 238 and an inside of the inner case 238. The Hall sensor 235 senses magnetism with the first magnetic member 233 to enable a calculation of a wound/rolled length of the display unit 220. This shall be described in detail with reference to FIG. 14A and FIG. 14B as follows.

FIG. 14A and FIG. 14B are separate diagrams of the Hall sensor 235 shown in FIG. 12C. First of all, referring to FIG. 14A, four Hall sensors 235, i.e., first to fourth Hall sensors H1 to H4 are disposed on an inner circumference surface of the inner case 238 or in an inner space of the inner case 238 along a circumferential direction of the inner case 238 in a manner of being spaced apart from each other in a predetermined distance. In this case, the first to fourth Hall sensors H1 to H4 can sense a movement of the second magnetic member 234 by sensing a magnetism change of the second magnetic member 234 in the circumferential direction of the inner case 238.

In FIG. 14A or FIG. 14B, an arrow indicates a rotational direction of the inner case 238.

As the inner case 238 is rotated, the first to fourth Hall sensors H1 to H4 are rotated together with the inner case 238. In the state that the display unit 220 is exposed to the maximum, only the first Hall sensor H1 can sense the second magnetic member 234. Thereafter, if the inner case 238 is rotated counterclockwise, the display unit 220 is wound, rolled or coiled on the inner case 238 and then the second Hall sensor H2, the third Hall sensor H3 and the fourth Hall sensor H4 can sense the second magnetic member 234 in order. Thus, the first to fourth Hall sensors H1 to H4 can provide an information for measuring a length of the display unit 220 wound along the outer circumference surface of the inner case 238. According to the information, if the sensor having sensed the second magnetic member 234 last on winding/rolling or unwinding/unrolling the display unit 220 is known, it is able to calculate a wound/rolled or unwound/unrolled size of the display unit 220. This is also applicable to a case of winding/rolling the display unit 220 on the inner case 238 multiple times. Yet, if the display unit 220 is wound/rolled over two layers on the outer circumference of the inner case 238, a change of magnetism occurs in a radial direction of the inner case 238. Hence, if the Hall sensor 235 capable of sensing the magnetism change is provided, it is able to measure a wound/rolled length of the display unit 220 more accurately.

For instance, if at least two Hall sensors 235 are disposed in a radial direction of the inner case 238 in a manner of being spaced apart from each other in a predetermined distance, as shown in FIG. 14B, it is able to sense a magnetism change of the second magnetic member 234 stacked twice at least on the outer circumference surface of the inner case 238, whereby a more accurate wound or rolled length of the display unit 220. FIG. 14 shows one example that three sensors (i.e., fifth to seventh Hall sensors H5 to H7) are disposed, by which the present embodiment is non-limited. Alternatively, at least two Hall sensors 235 can be provided along a radial direction of the inner case 238 so as to sense a magnetism change of the second magnetic member 234 stacked on the outer circumference surface of the inner case 238. In particular, the fifth to seventh Hall sensors H5 to H7 can sense a magnetism change caused by the second magnetic member 234 in the radial direction of the inner case 238.

In more particular, while the display unit 220 is rolled into one later on the inner case 238 in the state shown in FIG. 12C, it is able to calculate a rolled length using the first to fourth Hall sensors H1 to H4. In case that the display unit 220 is rolled in a manner of being stacked into two layers on the inner case 238, the fifth to seventh Hall sensors H5 to H7 can sense a magnetism change in the radial direction. Thereafter, a rolled length can be calculated by the first to fourth Hall sensors H1 to H4 again. If the display unit 220 is tacked into 3 layers in the radial direction along which the fifth to seventh Hall sensors H5 to H7 are formed, a magnetism change can be sensed by the fifth to seventh Hall sensors H5 to H7. Thus, it is able to calculate a length of the display unit 220 rolled on the outer circumference surface of the inner case 238 using the first to fourth Hall sensors H1 to H4. Although the display unit 220 is rolled by being staked into multiple layers on the outer circumference surface of the inner case 238, it is able to calculate a length of the rolled display unit 220 using the first to fourth Hall sensors H1 to H4. Yet, for more accurate measurement, it is necessary to refer to information on a magnetism change sensed by the fifth to seventh Hall sensors H5 to H7. In doing so, each of the first Hall sensor H1 and the fifth Hall sensor H5 may include the same Hall sensor 235.

Meanwhile, according to the aforementioned structure of the mobile terminal 200, in order to adjust the display unit 220 and a size of a screen formed on the display unit 220, extension and contraction of the display unit 220 can be appropriately performed. Yet, in order to provide a further improved function, i.e., in order to well show a content or screen intended for a user at least, a display of the content or screen needs to be associated with an extended direction and disposition of the display unit 220, which needs to be supported by a proper control in consideration of the structure and property of the device 200. Moreover, in implementing an intended function, the mobile terminal 200 is basically accompanied by interactions with a user. Hence, optimization of various controls can achieve improvements of user environment and user interface of a user and an intended functional improvement more effectively and efficiently. Furthermore, such user experiences as facilitation in using the mobile terminal 200, convenience in using the mobile terminal 200 and the like can be remarkably improved by the optimized controls. For this reason, a method of controlling the mobile terminal 200 shown in FIGS. 1 to 14 has been developed and is described in detail with reference to the related drawings in addition to FIGS. 1 to 14 as follows. Unless there are especially opposed descriptions, FIGS. 1 to 14 and the descriptions with reference to FIGS. 1 to 14 are basically included in and referred to for the description and drawings of the controlling method in the following. Yet, the controlling method in the following is not provided for one embodiment of the mobile terminal shown in FIGS. 1 to 14 only. The controlling method in the following is applicable to all kinds of mobile terminals 200 capable of implementing the size adjustment of the display unit 200 by the basic concept or principle of the mobile terminal shown in FIGS. 1 to 14, and more particularly, by the extension and contraction of the display unit 220. And, it is apparent to those skilled in the art that these applications belong to the scope of the appended claims and their equivalents of the present application.

Controlling methods described in the following can control operations of the components (i.e., various parts) described with reference to FIGS. 1 to 14 and can provide the intended functions based on such operations. Hence, operation and functions related to the controlling method may be regarded not only as the features of the controlling method but also as the features of all related structural components. In particular, the controller (or processor) 180 can be called one of various names such as a control unit, a controlling device and the like and is able to control all the components of the mobile terminal 200 to perform a prescribed operation. Therefore, the controller 180 substantially controls all methods and modes mentioned in the following description of the present application, whereby all the steps mentioned in the following description may become the features of the controller 180. For such reasons, all the detailed steps and features in the following should be understood as the features of the controller 180 despite failing to be described as performed by the mobile terminal 200. Moreover, the structural aspects and corresponding operations in the following description of the controlling method may refer to the former descriptions with reference to FIGS. 1 to 14, whereby third tails shall be omitted from the following description.

As discussed in the foregoing description, the mobile terminal 200 may include the body part 210 configured to accommodate various parts or components and the flexible display unit 220 configured to extend from or contract (or, retract) into the body part 210. For clarity of the description, the body part 210 and the flexible display unit 220 are simply represented as the body 210 and the display 220, respectively. And, such representations do not make substantial differences. In order to use the mobile terminal 200, the display 220 can be withdrawn from the body 210 and can be extended into a size desired by a user. Yet, owing to such a structure, the display 220 can be extended in various directions by a user and a relative orientation of the display 220 toward a user may vary in accordance with an extension direction. In particular, depending on an extending direction of the display 220, e.g., a right-directional extension or a left-directional extension, a relative position of a specific portion of the display 220 (e.g., a top portion of the display 220) toward a user may be changed. Hence, in order to show an intended content or screen to a user well, the mobile terminal needs to orient the content or screen on the display in consideration of the relative orientation or disposition of the changed display or user. Hence, the present application can provide a controlling method S10 for such an appropriate orientation. And, the controlling method S10 is described in detail with reference to the related drawings as follows.

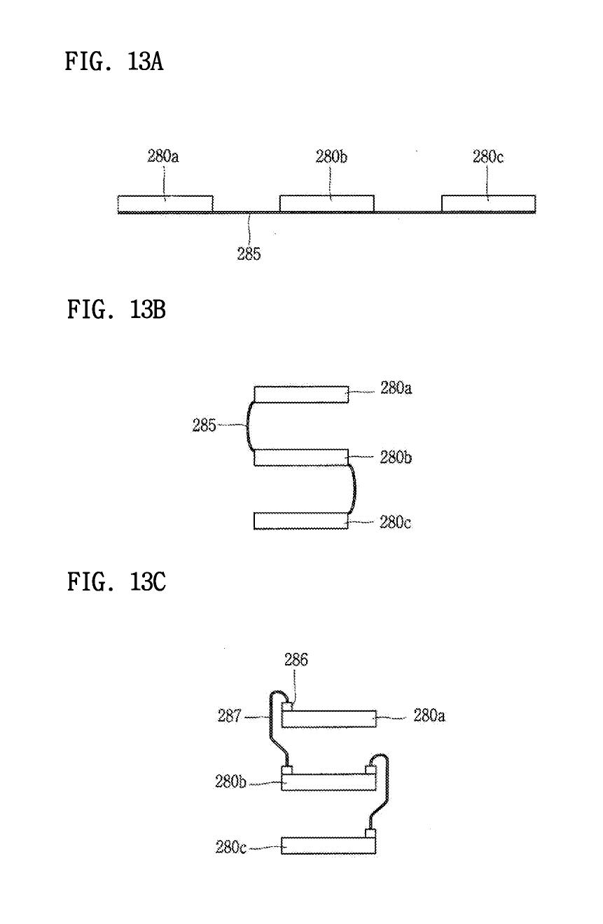

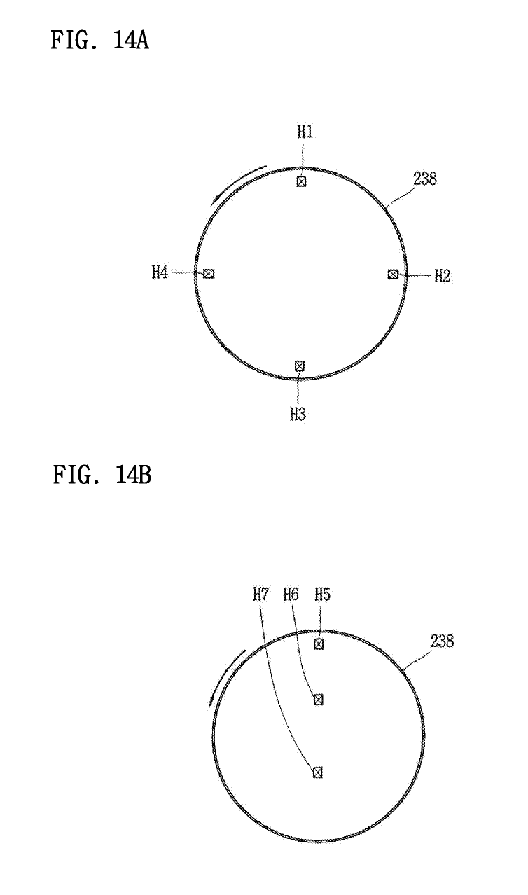

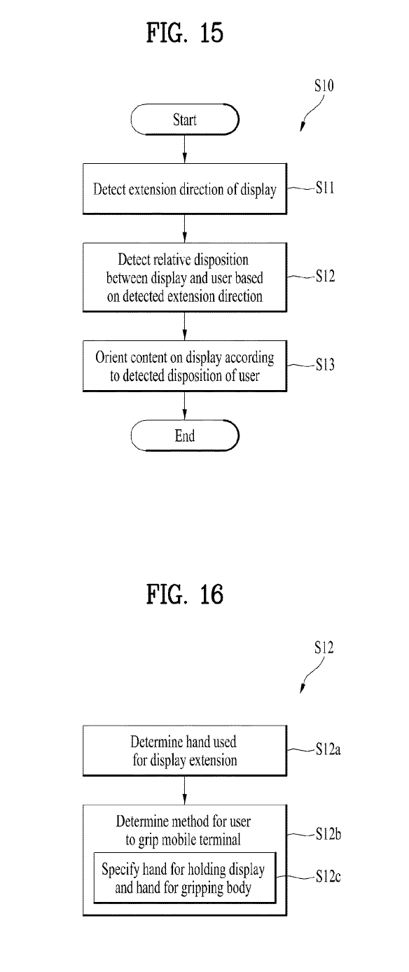

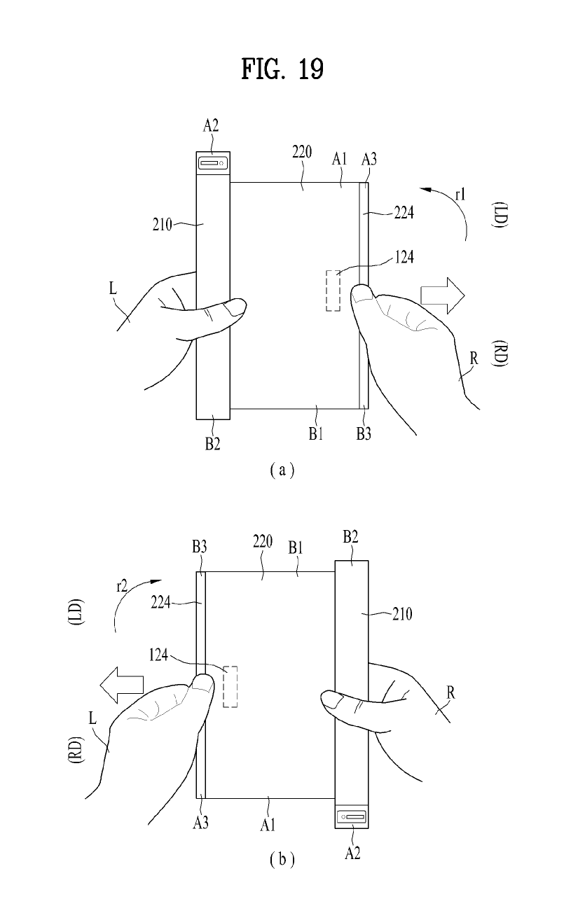

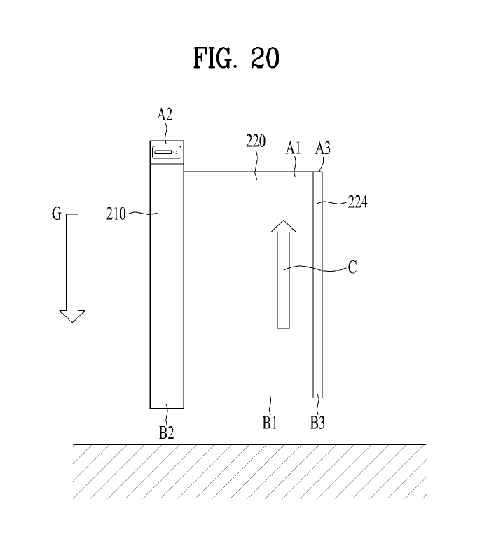

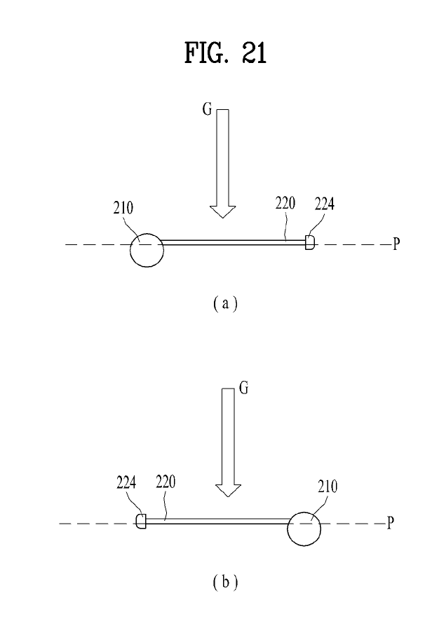

FIG. 15 is a flowchart for one example of a method of controlling a mobile terminal described in the present application, FIG. 16 is a detailed flowchart of a detecting step of relative disposition shown in FIG. 15, and FIG. 17 is a detailed flowchart of an orientation step of a content shown in FIG. 15. FIG. 19 is a layout to describe user's tendency for a display extension. FIG. 20 is a front diagram of a mobile terminal oriented overall in a direction horizontal to a gravity direction. And, FIG. 21 is a front diagram of a mobile terminal oriented overall in a direction vertical to a gravity direction.

First of all, referring to FIG. 15, the mobile terminal 200 can detect an extension direction of the display 220 [S11]. As shown in FIG. 19, the display 220 can be extended in various directions by a user. For such extension, the user can withdraw the display 220 from the body 210 by holding the holder 224. Moreover, the user can withdraw the display 220 by directly holding the display 220 without using the holder 224. For instance, as shown in FIG. 19 (a), the user can extend the display 220 in a right direction. For another instance, as shown in FIG. 19 (b), the user can extend the display 220 in a left direction. Yet, as mentioned in the foregoing description, the relative orientation or disposition of the display 220 for a user can be changed in accordance with a change of the extension direction. For instance, referring to FIG. 19 (a) showing that the display 220 is extended in a right direction, the mobile terminal 200 can include first parts A1, A2 and A3 of the display 220, body 210 and holder 24 disposed on regions relatively upper than other parts in user's view and second parts B1, B2 and B3 of the display 220, body 210 and holder 24 disposed on regions relatively lower than other parts in user's view. Yet, referring to FIG. 19 (b), if the display 220 is extended in a left direction, the upper parts A1, A2 and A3 are disposed in a relatively lower region in user's view and the lower parts B1, B2 and B3 can be disposed in a relatively upper region. As shown in the real examples, the change of the extension direction may bring the chance of the orientation or disposition of the whole mobile terminal 200. In particular, in accordance with the change of the extension direction, a relative position of a specific portion of the display 220 gains a user or a relative position of a user to the specific portion of the display 220 can be changed. Thus, since the change of the orientation or disposition occurs relatively between the user and the display 220, the change of the extension direction can be described as changing the relative orientation or disposition of the user to the display 220 as well as the relative orientation/disposition of the display 220 to the user. Eventually, the change of the extension direction can be described as changing the relative disposition and orientation between the user and the display 220.

If a same portion of a content or screen is displayed on a same portion of the display 220 without considering a changed relative disposition and orientation, a content may not be shown to a user well. For instance, referring to FIG. 9 (a), if an upper part of a content or screen is displayed on the first part A1 of the display 200, as the first part A is disposed on an upper region relative to the user, the content can be well shown to the user overall. Yet, referring to FIG. 9 (b), the first part A is disposed on a lower region relative to the user. Hence, in FIG. 9 (b), if the upper part of the content or screen is disposed on the first part A like FIG. 9 (a), the content is displayed inversely overall. Hence, the user may have difficulty in recognizing the content or screen well. Hence, in order to show an intended content or screen to a user well, the mobile terminal needs to dispose or orient the content or screen on the display in consideration of the changed relative orientation between the display and the user.

As discussed in the foregoing description, for the appropriate disposition and orientation of a screen, a relative disposition or orientation between a user and the display 220 should be determined in the first place, which can be performed one of various methods. As mentioned in the foregoing description, since the change of the extension direction is the most basic reason for bringing the change of the relative disposition and orientation, it is able to most easily obtain the relative disposition or orientation between the user and the display 220 using the extension direction selected from the various methods. Hence, in the controlling method S10 according to the present application, the detecting step S11 can be performed preferentially. In the detecting step S11, the mobile terminal 200 can use the acceleration sensor or the gyro sensor 124, as shown in FIG. 19, among the various methods and devices in order to detect the extension direction. The acceleration or gyro sensor (hereinafter named a sensor) 124 can basically sense a size and direction of acceleration of a moving object. Moreover, by sensing the acceleration, the sensor 124 is able to sense a moving direction of the object as well. For an extension, as shown in FIG. 19, the display 220 should move in a prescribed direction. In particular, the display 220 is extended in the moving direction of its own. The sensor 124 is able to sense the moving direction of the display 220 relative to the body 210 by sensing the size and direction of the acceleration generated from the movement of the display 220. Hence, the mobile terminal 200 senses the moving direction of the display 220 using the sensor 124, thereby sensing the extension direction of the display 220. In order to help the detection of the moving direction of the display 220, as shown in FIG. 19, the sensor 124 can be directly installed in the display 220. Moreover, since the holder 224 moves together with the display 220 in the same direction, the holder 224 may contain the sensor 124.

After the detecting step S11, the mobile terminal 200 can detect a relative disposition or orientation between the display 220 and the user based on the detected or sensed extension direction of the display 220 [S12]. In the orientation detecting step S12, as shown in FIG. 16, in order to detect the relative disposition and orientation, the mobile terminal 200 can determine which hand is used for the extension of the display 220 by the user from the detected extension direction of the display 220 [S12a]. Generally, a person (i.e., user) can use one of a right hand and a left hand more skillfully than the other. In particular, the right-handed person skillfully uses the right hand, while the left-handed person skillfully uses the left hand. Thus, as the user tends to mainly use the hand skillfully used by the user, such tendency is identically applicable to a case that the user moves a prescribed object. For instance, as shown in FIG. 19 (a), if the user is a right-handed person, the user tends to extend the display 220 in a right direction from the body 210 using a right hand R. On the contrary, if the user is a left-handed person, as shown in FIG. 19 (b), the user tends to extend the display 220 in a left direction from the body 210 using a left hand L. Therefore, based on such user's tendency, it is able to determine that which hand is used for the extension by the user by detecting or sensing the extension direction of the display 220. Referring to the example shown in FIG. 19 (a), if it is detected that the display 220 has been extended in the right direction, the mobile terminal 200 can determine that the user has used the right hand for the extension of the display 200. Moreover, referring to the example shown in FIG. 19 (b), if it is detected that the display 220 has been extended in the left direction, the mobile terminal 200 can determine that the user has used the left hand for the extension of the display 200.

Thereafter, the mobile terminal 200 can determine a manner for the user to grip the mobile terminal 200 [S21b]. if it is determined that the user uses a prescribed hand for the extension of the display 200 in the determining step S12a, the mobile terminal 200 can determine whether the user is the right-handed person or the left-handed person. Hence, the mobile terminal 200 can specify the hand for holding the display 220 and the hand for gripping the body 210 [S12c]. For instance, as shown in FIG. 19 (a), if the extension in the right direction and the use of the right hand are determined, the mobile terminal 200 can determine that the user holds the display 200 with the right hand R and that the user grips the body 210 with the left hand L. Moreover, as shown in FIG. 19 (b), if the extension in the left direction and the use of the left hand are determined, the mobile terminal 200 can determine that the user holds the display 200 with the left hand L and that the user grips the body 210 with the right hand R.

Thus, if the mobile terminal 200 determines how the user grips the mobile terminal 200, it is finally able to determine the relative disposition and orientation between the user and the mobile terminal 200 including the display 220. For instance, as shown in FIG. 19 (a), since the mobile terminal 200 determines that the right hand R of the user holds the display 220 and that the left hand L of the user grips the body 210, the mobile terminal 200 can determine that the first parts A1, A2 and A3 are disposed in the region upper than other portions in user's view. And, as shown in FIG. 19 (b), since the mobile terminal 200 determines that the left hand L of the user holds the display 220 and that the right hand R of the user grips the body 210, the mobile terminal 200 can determine that the second parts B1, B2 and B3 are disposed in the upper instead of the first parts A1, A2 and A3 in user's view.

Thereafter, the mobile terminal 200 can orient or dispose the content or screen on the display 220 in accordance with the detected relative disposition [S13]. In this disposing step S13, based on the detected disposition substantially, the mobile terminal 200 specifies portions of the display on which the upper part and/or lower part of the content or screen will be disposed and is able to display the corresponding portions of the content or screen on the specified portions of the display 220. For instance, referring to FIG. 19 (a), based on the detected relative disposition, the mobile terminal 200 can specify that the first part A1 of the display 220 is located on the upper part against the user and that the second part B1 is located on the lower part against the user. Hence, the mobile terminal 200 can display the upper part and the lower part of the content or screen on the first part A1 and the second part B1, respectively. On the other hand, referring to FIG. 19 (b), based on the detected relative disposition, the mobile terminal 200 can specify that the second part B1 of the display 220 is located on the upper part against the user and that the first part A1 is located on the lower part against the user. Hence, the mobile terminal 200 can display the upper part and the lower part of the content or screen on the second part B1 and the first part A1, respectively. By the specifying and displaying, the content and/or screen can be appropriately disposed or oriented fort the user, thereby being well shown to the user.

A step of displaying the content after the above-described specifying can be actually performed by one of various methods. And, such a displaying step is described in detail as follows. First of all, referring to FIG. 17, the mobile terminal 200 can orient or dispose the content or screen on the display 220 in a manner that the content or screen is roughly vertical to the detected extension direction of the display [S131]. Thereafter, if the display 220 is extended in a right direction, as shown in FIG. 19 (a), the content can be rotated at a prescribed angle in a counterclockwise direction r1 from the extension direction [S13b]. Moreover, if the display 220 is extended in a left direction, as shown in FIG. 19 (b), the content can be rotated at a prescribed angle in a clockwise direction r2 from the extension direction [S13c]. On the other hand, after the disposing step S13a, if the display 220 is extended in the right direction, as shown in FIG. 19 (a), the mobile terminal 200 can dispose the upper part of the content on an end portion (i.e., the first part A1) of the display located on a left side LD of the extension direction. Moreover, after the disposing step S13a, if the display 220 is extended in the left direction, as shown in FIG. 19 (b), the mobile terminal 200 can dispose the upper part of the content on an end portion (i.e., the second part B1) of the display located on a right side RD of the extension direction. By the displaying step mentioned in the foregoing description, the content can be disposed on the display 220 so as to be well shown to the user.

The acceleration or gyro sensor 124 can sense a working direction and size of gravity as well as a size and direction of acceleration. Hence, using the sensed gravity working direction, the mobile terminal 200 can directly obtain the relative disposition of the whole mobile terminal 200 to the user. For instance, referring to FIG. 20, if the mobile terminal 200 is oriented substantially vertical to a gravity direction G, it is able to detect the parts A1 to A3 disposed on an upper side along the gravity direction G and the parts B1 to B3 disposed on a relatively lower side with reference to the gravity direction G. In particular, the mobile terminal 200 can detect that the first part A2 of the display 220 is located on a relatively upper side in user's view and that the second part B2 is located on a relatively lower side in user's view. Hence, without the indirect determinations of the detection of the extension direction and the relative disposition according to the controlling method S10, the mobile terminal 200 can directly detect the relative disposition using the sensor 124 and is able to appropriately orient the content or screen for the user. In particular, since the user is oriented in a direction opposite to the gravity direction G, the content or screen can be directly oriented in a direction C opposite to the detected gravity direction G to be well shown to the user. Such an orienting method may be applicable to the mobile terminal 200 disposed to incline at a prescribed angle with the gravity direction as well as to the mobile terminal 200 in parallel with the gravity direction G.

On the other hand, as shown in FIG. 21, the mobile terminal 200 can be oriented to be substantially vertical to the gravity direction G. For instance, when the mobile terminal 200 is placed on the ground or table, it can be oriented to be vertical to the gravity direction G. such a mobile terminal 200 can be disposed in a common plane P actually vertical to the gravity direction G and a size of the gravity may be equal in the common plane P. Moreover, due to the same gravity size, the sensor 124 is unable to sense a working direction of the gravity. Hence, referring to FIG. 21 (a) or FIG. 21 (b), when the display 220 is extended in a right direction or a left direction, the mobile terminal 200 senses such an extension direction, thereby being able to effectively detect a relative disposition or orientation between the display unit 220 and the user at least. For such reasons, the controlling method S10 using the extension direction may become the most effective method in determining the relative disposition or orientation of the mobile terminal 200 oriented in a direction substantially vertical to the gravity direction G. Moreover, as shown in FIG. 21, the controlling method S10 can be still effectively applicable to the mobile terminal 200 disposed to incline at a prescribed angle with the gravity direction G for the detection of the relative disposition or orientation of the mobile terminal 200 as well as to the mobile terminal 200 in parallel with the gravity direction G.

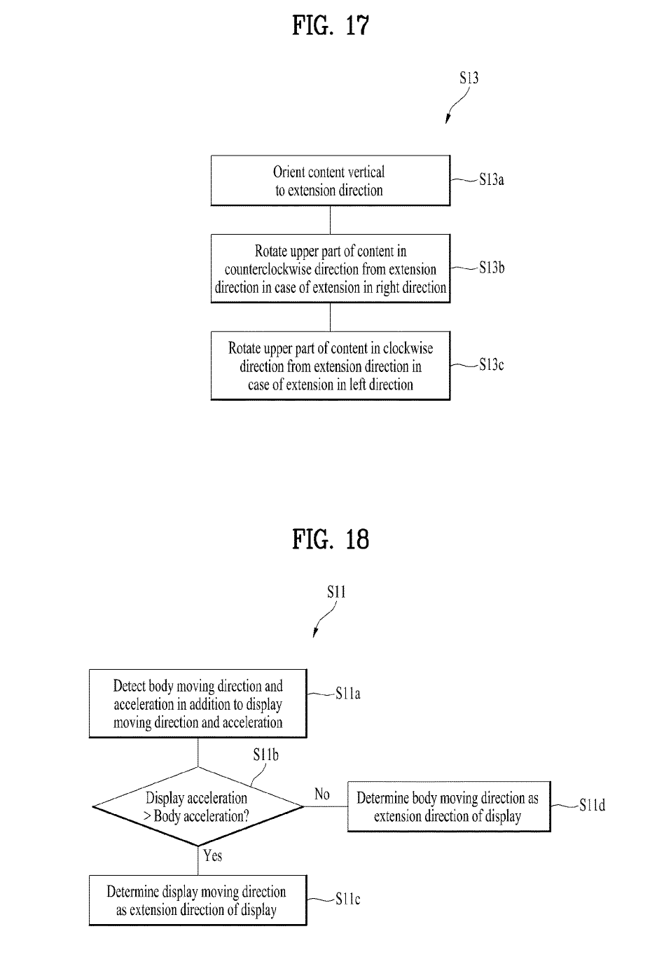

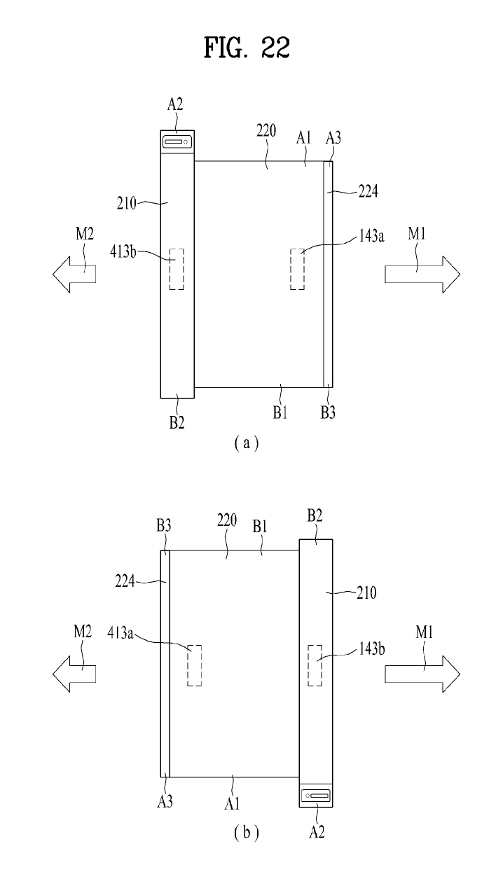

Meanwhile, as mentioned in the foregoing description, the controller method S10 considers a moving direction of the display 220 for the detection of the extension direction of the display 220. Hence, despite that the controlling method S10 appropriately detects the relative disposition between the display 220 and a user in most cases, while the body 210 stands still, when the display 220 is moved for extension only, the controlling method S10 can perform a most accurate detection of a relative disposition. Yet, a user may often move both of the body 210 and the display 220 to extend the display 220. For instance, the user may move the body 210 and the display 220 in the right direction and the left direction, respectively. In this case, for an accurate measurement between the display 220 and the user, the mobile terminal 200 needs to detect an extension direction of the display 220 accurately in the first place. Hence, the detecting step S11 can be modified for the display 200 and the body 210 moved together, which will be described in detail with reference to the related drawings later. FIG. 18 is a detailed flowchart of an extended direction detecting step shown in FIG. 11. And, FIG. 22 is a layout of a body and display moving together for extension of the display.

First of all, referring to FIG. 18, the mobile terminal 200 can detect moving directions and acceleration sizes of the display 220 and the body 210 [S11a]. In the detecting step S11a, as shown in FIG. 22, the mobile terminal 200 can use the acceleration or gyro sensors 124 and 124b in various methods and devices to detect an extension direction. In this case, as mentioned in the foregoing description, the acceleration or gyro sensors (hereinafter called ‘sensors’) 124a and 124b are also able to detect a moving direction as well as an acceleration size and direction of a moving object. In order to be advantageous in detecting a moving direction and an acceleration, the sensors 124a and 124b may be installed in the display 220 and the body 210 to be advantageous in detecting a moving direction and an acceleration, respectively. In particular, the sensor 124a can detect a moving direction and acceleration of the display 220, while the sensor 124b can detect a moving direction and acceleration of the body 210.

Thereafter, the mobile terminal 220 can compare the detected acceleration of the display 220 and the detected acceleration of the body 210 to each other [S11b]. As discussed in the foregoing description, the user is able to use one of hands more skillfully than to use the other. Hence, the more skillfully used hand is used more frequently than the other and can exert power greater than that of the other. Hence, when the user moves both of the display 220 and the body 210, the user can move the display 220 or the body 210, which is held or gripped with the more skillful hand of the user, faster. And, the corresponding display 220 or body 210 can have a greater acceleration. For such reasons, based on the comparison result, the mobile terminal 200 can determine a moving direction of the display 220 or the body 210, which has the greater acceleration, as the extension direction of the display 220.

In particular, referring to FIG. 22 (a), if the acceleration M1 of the display 220 is greater than the acceleration M2 of the body 210, the mobile terminal 200 can determine the moving direction M1 of the display 220 as the extension direction of the display 220 [S11c]. On the other hand, referring to FIG. 22 (b), if the acceleration M1 of the body 210 is greater than the acceleration M2 of the display 220, the mobile terminal 200 can determine the moving direction M1 of the body 210 as the extension direction of the display 220 [S11d].

After the extension direction detecting step S11, referring to FIG. 15 and FIG. 16, the mobile terminal 200 specifies the hand for holding the display 220 and the hand for gripping the body 210 [S12c], thereby being able to determine a manner for the user to grip the mobile terminal 200 in order to detect a relative disposition between the user and the display 220 [S12b]. In particular, in case of FIG. 22 (a), since the moving direction of the display 220, i.e., the right direction is the extension direction, the mobile terminal 200 can determine that the user holds the display 220 with the right hand and grips the body 210 with the left hand. Moreover, in case of FIG. 22 (b), since the moving direction of the display 220, i.e., the left direction is the extension direction, the mobile terminal 200 can determine that the user grips the body 210 with the right hand and holds the display 220 with the left hand. Therefore, based on specifying the hands, the mobile terminal 200 can effectively detect the relative disposition between the user and the display 220 [S12], whereby the content and screen can be oriented appropriately [S13].

According to the detecting steps S11a to S11d mentioned in the foregoing description, by measuring the moving directions and accelerations of both of the display 220 and the body 210 for the determination of the extension direction, it is able to clearly obtain the real moving directions of the display 220 and the body 210. Therefore, the mobile terminal 200 can accurately specify the hand for holding the display 220 and the hand for gripping the body 210, thereby being able to accurately detect the relative disposition and orientation between the user and the display 220. For the same reason, in case that the display 220 is moved for extension only, the detecting steps S11a to S11d can apply to the more accurate detection of the relative disposition.

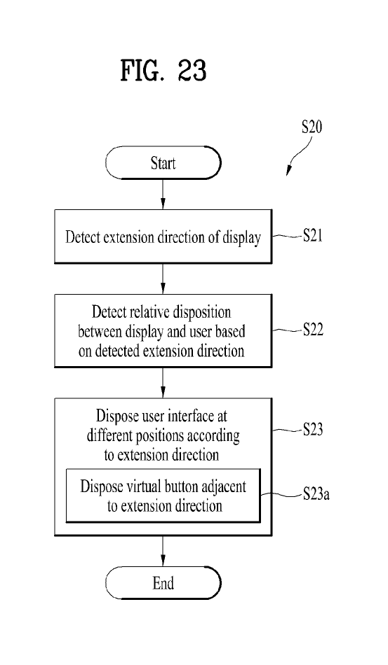

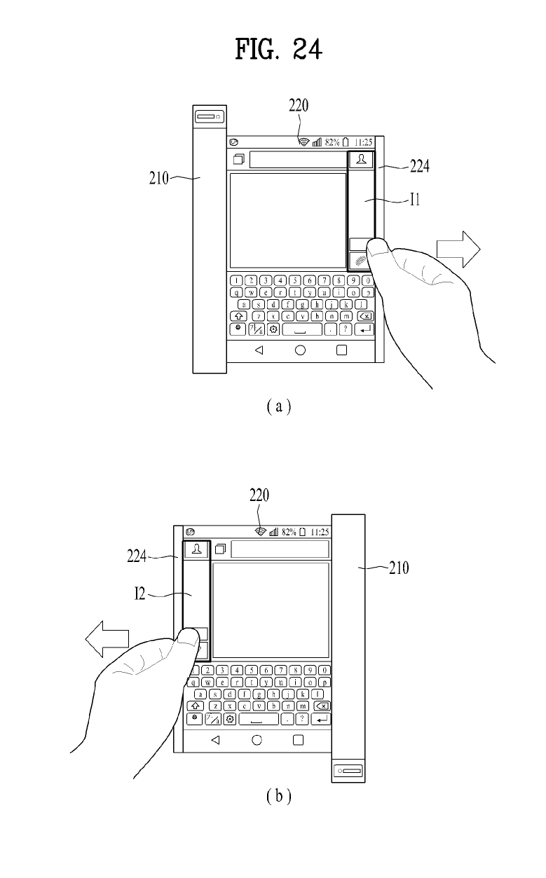

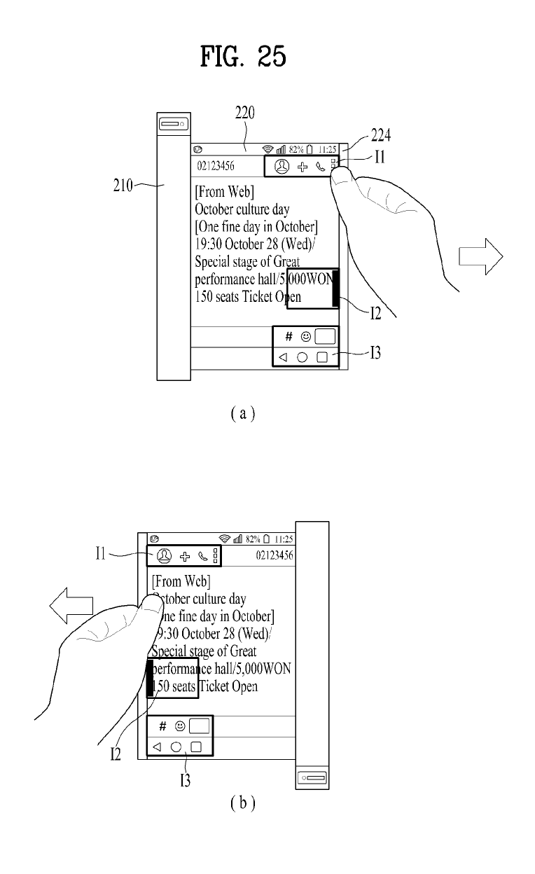

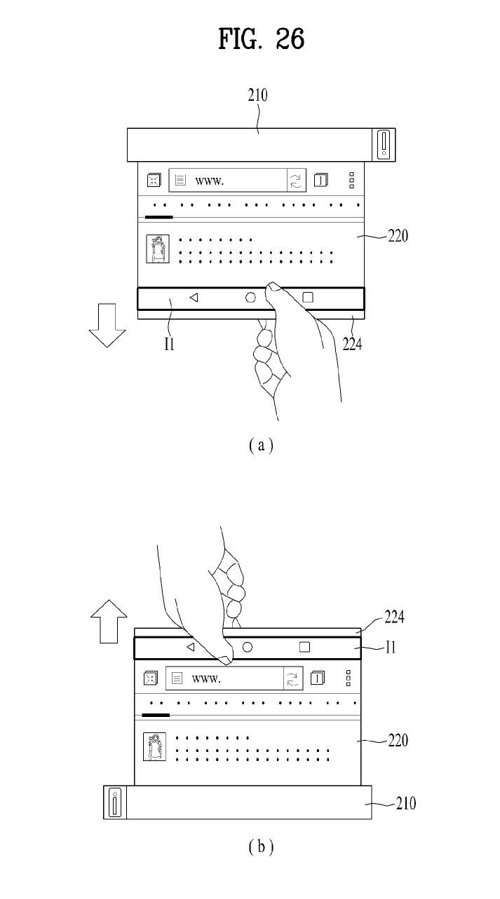

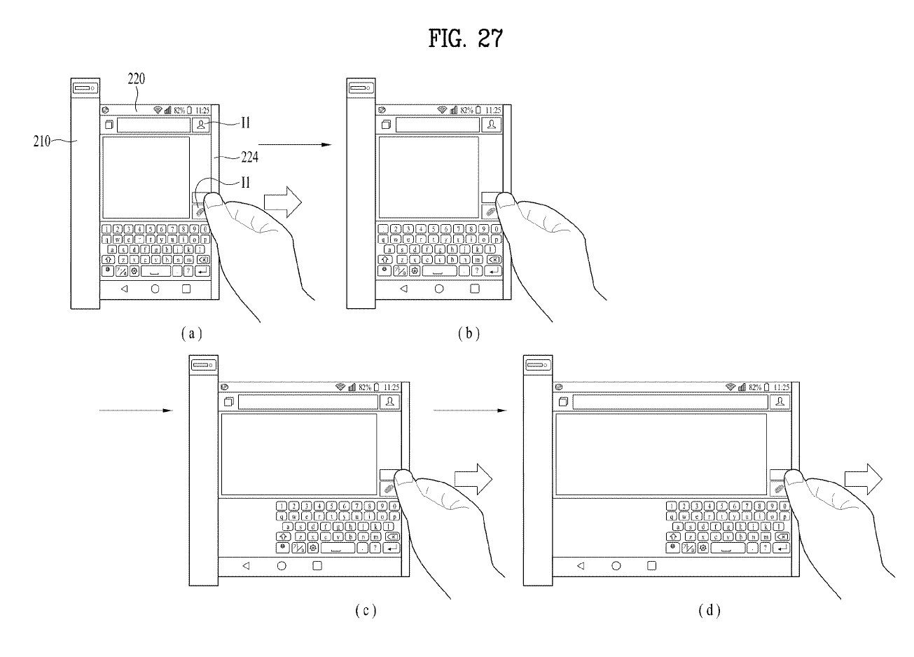

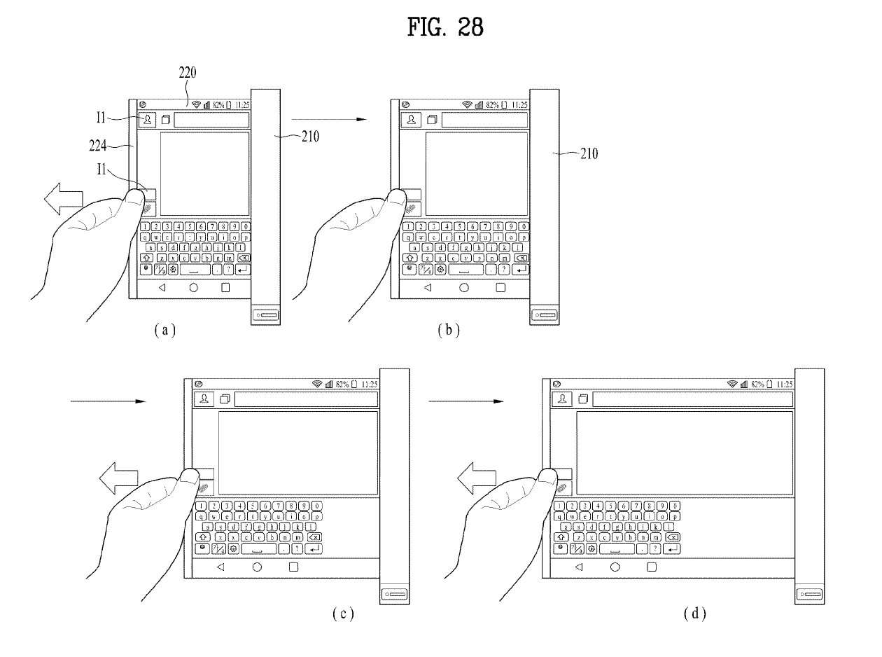

Meanwhile, the mobile terminal 200 performs an interaction with a user to provide an intended function. For such an interaction, the mobile terminal 200 can provide a user interface. Since an overall orientation or disposition of the mobile terminal 200 including the display 220 is changed in accordance with an extension direction of the display 220, it may be preferable that the user interface is changed correspondingly for user's convenient use. Hence, in addition to an appropriate orientation of a content according to the controlling method S10, the mobile terminal 200 can additionally adjust the content and screen to match the relative orientation between the mobile terminal 200 and the user. In particular, the user interface may include a virtual interface provided through the display 220 and a physical interface installed on a prescribed portion of the mobile terminal 200 with a substantial shape. First of all, the present application is able to provide a controlling method S20 for adjusting the virtual interface to fit a relative orientation. FIG. 23 is a flowchart for another example of a method of controlling a mobile terminal described in the present application, FIG. 24 is a layout for one example of a user interface provided by the controlling method shown in FIG. 23, and FIG. 25 is a layout for another example of a user interface provided by the controlling method shown in FIG. 23. FIG. 26 is a layout for further example of a user interface provided by the controlling method shown in FIG. 23. And, FIG. 27 and FIG. 28 are layouts for examples of a user interface provided by the controlling method shown in FIG. 23 when sizes of a display and screen are changed.

First of all, referring to FIG. 23, the mobile terminal 200 can detect an extension direction of the display 220 [S21]. After the detecting step S21, the mobile terminal 200 can detect a relative disposition or orientation between the display 220 and a user based on the detected extension direction of the display 220 [S22]. The detecting steps S21 and S22 are substantially identical to the former detecting steps S11 and S12 shown in FIG. 15. Hence, with respect to the detecting steps S21 and S22, the descriptions of the former detecting steps S11 and S12 are referred to and additional description shall be omitted from the following.

After the detecting step S21, the mobile terminal 200 can provide a different user interface in accordance with the detected extension direction of the display 220 [S23]. In particular, the mobile terminal 200 can dispose the user interface, i.e., a virtual interface on one of different locations on the display 220 [S23]. As discussed in the foregoing description, the virtual interface is visually displayed as an image or graphic on the display 220 and may consist of various elements. The user may use a virtual input unit for an input to the mobile terminal 220 among the various elements most frequently. As shown in FIGS. 25 to 28, the virtual input unit may include a virtual button I1, a screen scroll I2, an input window 13, a virtual keyboard and the like. As mentioned in the foregoing description, the user may extend the display 220 using a skillful hand of the user. Hence, if the virtual input units I1 to I3 are disposed adjacent to the extension direction, the skillful hand of the user can easily access the virtual input units I1 to I3. For such a reason, in the providing step S23, the mobile terminal 200 can dispose the virtual input units I1 to I3 to be adjacent to the extension direction of the display 220 on the display 220 [S23a]. Likewise, in most cases, the user applies an input to the mobile terminal 200 using a skillful hand of the user. Hence, for user's convenient input, the mobile terminal 200 can dispose the virtual input units I1 to I3 to be adjacent to the hand for moving the display 220, i.e., the hand for holding the display 220.

In particular, for instance, as shown in FIG. 24 (a) and FIG. 25 (a), if the display 220 is extended in a right direction, the mobile terminal 200 can dispose the virtual input units I1 to I3 on a right end portion of the display 220. Moreover, as shown in FIG. 24 (b) and FIG. 25 (b), if the display 220 is extended in a left direction, the mobile terminal 200 can dispose the virtual input units I1 to I3 on a left end portion of the display 220. Similarly, as shown in FIG. 26 (a), if the display 220 is extended in a bottom direction, the mobile terminal 200 can dispose the virtual input units I1 to I3 on a bottom end portion of the display 220. As shown in FIG. 26 (b), if the display 220 is extended in a top direction, the mobile terminal 200 can dispose the virtual input units I1 to I3 on a top end portion of the display 220. Furthermore, as shown in FIG. 27 (a), FIG. 27 (b), FIG. 28 (a) and FIG. 28 (b), in case that a size of a content or a screen is equal to or greater than that of an extended display 220, the virtual input units I1 to I3 can be disposed on a right or left end portion of the display 220 in accordance with an extension direction of the display 220 for user's convenient input. Similarly, as shown in FIG. 27 (c), FIG. 27 (d), FIG. 28 (c) and FIG. 28 (d), in case that a size of a content or a screen is smaller than that of an extended display 220, the virtual input units I1 to I3 can be still disposed on a right or left end portion of the display 220 in accordance with an extension direction of the display 220 for user's convenient input. As shown in the actual examples of the disposition of the virtual input units I1 to I3 shown in FIGS. 25 to 28, the mobile terminal 200 can dispose the virtual input unit to be adjacent to the extension direction of the display 220 or the hand for moving the display 220. Hence, for user's convenient use, the virtual interface, i.e., the virtual input units I1 to I3 can be disposed on different locations on the display 220 in accordance with the extension direction.

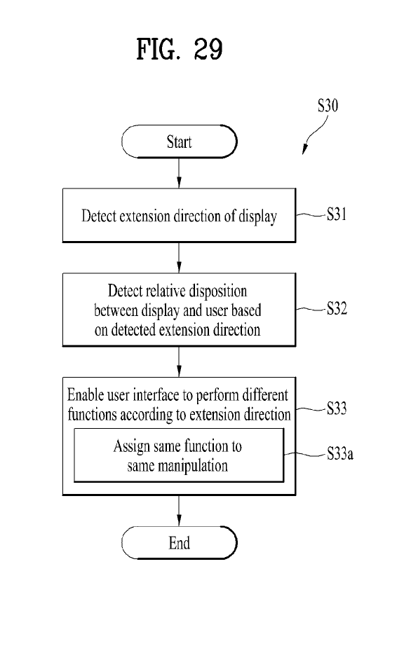

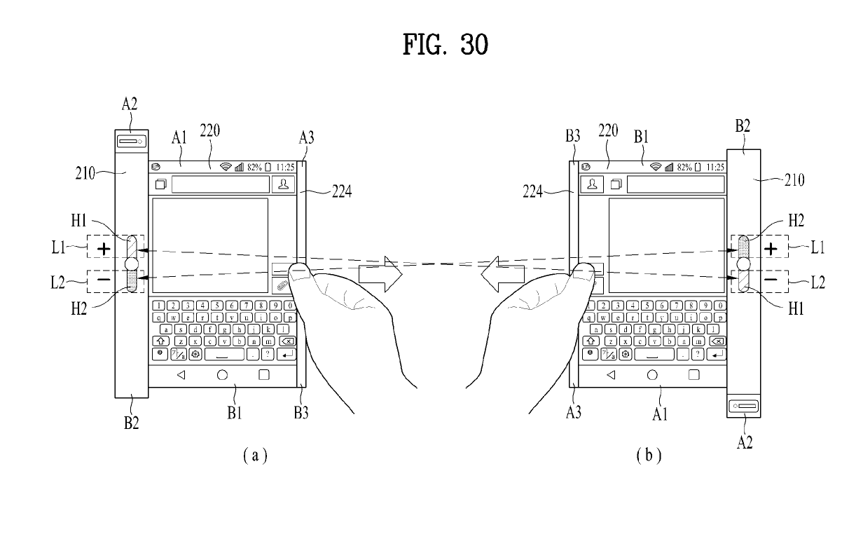

In continuation with the controlling method S20 for adjusting the virtual interface, the present application can provide a controlling method S30 for adjusting a physical interface to be appropriate for a relative orientation. Such a controlling method S30 is described in detail with reference to the related drawings as follows. FIG. 29 is a flowchart for further example of a method of controlling a mobile terminal described in the present application, and FIG. 30 is a layout for one example of a user interface provided by the controlling method shown in FIG. 29.

First of all, referring to FIG. 29, the mobile terminal 200 can detect an extension direction of the display 220 [S31]. After the detecting step S31, the mobile terminal 200 can detect a relative disposition or orientation between the display 220 and a user based on the detected extension direction of the display 220 [S32]. The detecting steps S31 and S32 are substantially identical to the former detecting steps S11 and S12 shown in FIG. 15. Hence, with respect to the detecting steps S31 and S32, the descriptions of the former detecting steps S11 and S12 are referred to and additional description shall be omitted from the following.

As discussed in the foregoing description, a physical interface may include a physical input device having a substantial shape and a physical output device having a substantial shape. The physical input device is mainly manipulated through user's hand(s) and may include a physical button, a physical key, a physical switch and the like. For instance, referring to FIG. 30, the mobile terminal 200 may include first and second volume buttons H1 and H2 configured to adjust a level of an outputted sound. In accordance with a change of the extension direction, as mentioned in the foregoing description, an orientation or disposition between the user and the rest of parts of the mobile terminal 200 (i.e., the physical interface) can be changed as well as the orientation or disposition between the user and the display 220. For instance, referring to FIG. 30 (a), when the display 220 is extended in a right direction, the first button H1 may be disposed on a relatively upper part than other parts in user's view like the first parts A1 to A3 and the second button H2 may be disposed on a relatively lower part than the first button H1 and other parts. Yet, referring to FIG. 30 (b), when the display 220 is extended in a left direction, the first button H1 may be disposed on a relatively lower part in user's view and the second button H2 may be disposed on a relatively upper part.

If a prescribed physical input device keeps performing the same function, it may be inconvenient for the user to use the corresponding physical input device due to the changed relative disposition and orientation. For instance, the first button H1 may perform a function of raising a volume and the second button H2 may perform a function of lowering the volume. Referring to FIG. 30 (a), since the first button H1 and the second button H2 are disposed on the relatively upper part and the relatively lower part in user's view, respectively, the given functions are harmonized with the disposition of the first and second buttons H1 and H2, whereby the user can use the first button H1 and the second button H2 conveniently. Yet, referring to FIG. 30 (b), due to the changed extension direction of the display 220 and the change of the orientation of the mobile terminal 200 according to the changed extension direction, the first button H1 is disposed on the lower part and the 2^{nd} button H2 may be rather disposed on the upper part. According to the change of the disposition, if the first button H1 and the second button H2 keep performing the same functions, respectively, it may be inconvenient for the user to use the buttons H1 and H2. In particular, in order to raise the volume in FIG. 30 (a), the first button H1 disposed on the upper part is pressed. On the other hand, in order to raise the volume in FIG. 30 (b), the first button H1 disposed on the lower part should be pressed instead of the second button H2 disposed on the upper part. Hence, as user's manipulation is changed in performing the same function, since the changed disposition of the manipulating/physical input device fails to be harmonized with the corresponding function, the user may be confused in suing the mobile terminal 200, and more particularly, the buttons H1 and H2.

Therefore, after the detecting step S31, the mobile terminal 200 can provide a different user interface according to the detected extension direction of the display 220 [S33]. In particular, the physical interface can perform different functions according to the extension direction instead of performing the same function all the time [S33]. In more particular, the mobile terminal 200 can assign the same function to the physical device located at the same relative position to the user [S33a]. In this assigning step S33a, the mobile terminal 200 can assign a prescribed function not to the physical input device but to a prescribed relative position to the user preferentially. Hence, if a prescribed physical input device is disposed at the prescribed relative position, the mobile terminal 200 can assign the prescribed function to the disposed physical input device. In particular, if a prescribed physical input device is disposed at a first position, the mobile terminal 200 can assign a function designated to the first position to the physical input device. Moreover, if the same physical input device is disposed at a second position different from the first position due to the changes of the relative disposition and orientation, a function designated to the second position may be assigned to the physical input device. For instance, as shown in FIG. 30, the mobile terminal 200 assigns a function of raising a volume to a first region or position L1 located on a relatively upper part in user's view and also assigns a function of lowering a volume to a second region or position L2 located on a relatively lower part. Hence, as shown in FIG. 30 (a), the function of raising the volume may be assigned to the first button H1 disposed at the first position L1 and the function of lowering the volume may be assigned to the second button H2 disposed at the second position L2. Yet, if the relative orientation or disposition is changed, as shown in FIG. 30 (b), the second button H2 disposed at the first position L1 can raise the volume, while the first button H1 disposed at the second position L2 can lower the volume. Hence, the mobile terminal 200 can always provide the same function in response to user's manipulation on a prescribed physical input device. In particular, as described in the example shown in FIG. 30, in user's view, the manipulation of the button disposed on the upper part may always play a role in increasing the volume and the manipulation of the button disposed on the lower part may always play a role in decreasing the volume.

Moreover, since a same function should be performed in response to a same manipulation, the physical input device can perform a different function according to a change of an extension direction of the display 220, i.e., a change of orientation or disposition of the mobile terminal 200. When a same function is performed in the controlling method S30, since user's manipulation is uniform and harmonized with the corresponding function, a user can use the mobile terminal 200, and more particularly, the buttons H1 and H2 more conveniently.

Since the aforementioned controlling methods S20 and S30 provide controls based on an extension direction of the display 220 like the former controlling method S10, all the steps of the controlling methods S20 and S30, and more particularly, the steps S23 and S34 may be performed in addition to the controlling method S10. Moreover, since the controlling methods S20 and S30 have distinguishable features and effects, they may be performed independently or individually.

Accordingly, the present application provides the following effects or features.

First of all, in the present application, a mobile terminal detects an extension direction of a display and is then able to detect a relative disposition or orientation between the display and a user based on the detected extension direction. Moreover, the mobile terminal can orient a content to be well shown to the user in consideration of an extension and disposition of the display. Therefore, the user can use the mobile terminal conveniently.

Secondly, a mobile terminal can adjust virtual and physical interfaces to be appropriate for users relative orientation to a display based on a detected extension direction. Therefore, by such adjustments, a user can use the mobile terminal more conveniently.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A rollable mobile terminal, comprising:
a body;
a flexible display that extends from and retracts into the body; and
a controller that detects the disposition of the display relative to a user based on a direction in which the user extends the display, and controls the orientation of content on the display in accordance with the detected disposition.

2. The rollable mobile terminal of claim 1, wherein in order to determine the disposition of the display, the controller determines, based on the direction in which the user extends the display, which hand the user is using to extend the display.

3. The rollable mobile terminal of claim 1, wherein in order to determine the disposition of the display, the controller determines, based on the direction in which the user extends the display, a manner in which the user is gripping the mobile terminal.

4. The rollable mobile terminal of claim 3, wherein in order to determine the manner in which the user is gripping the mobile terminal, the controller determines which hand is holding the display and which hand is gripping the body.

5. The rollable mobile terminal of claim 1, wherein based on the detected disposition of the display, the controller determines which portion of the display will include a first part of the content and which portion of the display will include a second part of the content.

6. The rollable mobile terminal of claim 1, wherein the controller controls the orientation of the content on the display in a manner of being vertical to the direction in which the user extends the display.

7. The rollable mobile terminal of claim 6, wherein when the display is extended in a right direction, the controller rotates the content by a prescribed angle in a counterclockwise direction, and
when the display is extended in a left direction, the controller rotates the content by a prescribed angle in a clockwise direction.

8. The rollable mobile terminal of claim 6, wherein when the display is extended in a right direction, the controller displays a first part of the content on a first end portion of the display and wherein when the display is extended in a left direction, the controller displays a second part of the content on a second end portion of the display.

9. The rollable mobile terminal of claim 1, wherein the body and the display, when extended, are oriented vertically.

10. The rollable mobile terminal of claim 1, wherein, when the user extends the display, the display moves relative to the user.

11. The rollable mobile terminal of claim 1, wherein when both the body and the display are moved by the user to extend the display, the controller detects the moving direction and acceleration of both the display and the body,
and wherein the controller determines the direction of extension to be the moving direction, of either the display or the body, which has a greater acceleration.

12. The rollable mobile terminal of claim 1, wherein each of the body and the display includes an acceleration sensor that measures an amount and direction of acceleration.

13. The rollable mobile terminal of claim 1, wherein the controller provides different user interfaces according to the direction in which the user extends the display.

14. The rollable mobile terminal of claim 1, wherein the controller changes the position of a virtual interface according to the direction in which the user extends the display.

15. The rollable mobile terminal of claim 1, wherein the controller controls a virtual input unit to be displayed adjacent to a predetermined portion of the display based on the direction in which the user extends the display.

16. The rollable mobile terminal of claim 1, wherein the controller controls a virtual input unit to be displayed adjacent to the hand of the user corresponding to the direction in which the user extends the display.

17. The rollable mobile terminal of claim 1, wherein when the user extends the display in a right direction, the controller controls a virtual input unit to be displayed on the right end portion of the display,
and when the user extends the display in a left direction, the controller controls the virtual input unit to be displayed on a left end portion of the display.

18. The rollable mobile terminal of claim 1, wherein the controller assigns functions to a physical interface according to the direction in which the user extends the display.

19. The rollable mobile terminal of claim 1, wherein the controller assigns a function to a physical input device according to the disposition of the physical input device relative to the user.
